(19) United States
(12) Patent Application Publication
(10) Pub. No.: US 2017/0039500 A1
(43) Pub. Date: Feb. 9, 2017

(54) SUPPLY CHAIN INTELLIGENCE SEARCH ENGINE

(71) Applicant: Thomson Reuters Global Resources, Baar (CH)

(72) Inventors: Jochen Lothar Leidner, Zug (CH); Ole Siig, Schwyz (CH)

(73) Assignee: Thomson Reuters Global Resources, Baar (CH)

(21) Appl. No.: 15/207,464

(22) Filed: Jul. 11, 2016

Related U.S. Application Data
(63) Continuation-in-part of application No. 13/594,864, filed on Aug. 26, 2012, now abandoned.
Application No. 13/594,864 is a continuation of application No. 13/795,022, filed on Mar. 12, 2013.

(51) Int. Cl. G06Q 10/06; G06Q 10/08; G06F 17/30

(52) U.S. Cl. CPC G06Q 10/06315; G06F 17/30864; G06Q 10/0833

(57) ABSTRACT

A Global Supply Chain Intelligence system (“GSCF”) configured as a supply chain intelligence search engine adapted to predict, discover and verify commodity trade flows. Creating and maintaining a dataset that tracks real and near real-time commodity flows as they happen as an input to the GSCI. The dataset used in a business intelligence process within the GSCI to arrive at an output, such as a predicted price behavior, a price alert, a risk alert, etc. A Commodity Flow Intelligence (CFI) component that collects and analyzes information with the timeliness, detail and accuracy required to track, forecast and predict supply and demand imbalances at the discrete flow level to aid market participants in making operational trading and investment decisions, for example, in connection with a financial services system or offering providing enhanced data and tools to promote market transparency.

### CROSS REFERENCE TO RELATED APPLICATION

The present application claims benefit of priority to and is a continuation-in-part of U.S. patent application Ser. No. 13/594,864, filed Aug. 26, 2012, and entitled METHODS AND SYSTEMS FOR MANAGING SUPPLY CHAIN PROCESSES AND INTELLIGENCE (Siig et. al.) and is a continuation of U.S. patent application Ser. No. 13/795,022, filed Mar. 12, 2013, and entitled METHODS AND SYSTEMS FOR GENERATING SUPPLY CHAIN REPRESENTATIONS (Leidner et. al.); all of which are hereby incorporated by reference herein in their entirety.

### FIELD OF THE INVENTION

This invention generally relates to search engines and related services including for use in mining and intelligent processing of data collected from content sources, e.g., in areas of financial services and risk management. More specifically, this invention relates to providing data and analysis useful in recognizing investment and supply chain related trends, threats and opportunities including risk identification using information mined from information sources.

### BACKGROUND OF THE INVENTION

At the most basic level government agencies and other bodies compile aggregated import/export statistics and release these say monthly and annually for various commodities and goods, e.g. how many barrels of crude did China import and export each month from what region or country. The problem faced by interested parties, such as investors and financial service providers that serve investors, is that by the time these statistics are released it is both too late and too aggregated to have significant value in terms of operational trading and investment decision.

A number of data sources and vendors track in particular vessels, which based on the vessel's characteristics and route track gives some indication of the cargo it may be carrying. However, these inferences of commodity flows are not accurate in terms of the actual commodity, quality and quantity being shipped and nor is the ownership and transactions parties to the cargo identified.

Ongoing supply and demand imbalances can have major impact on price and thus having detailed and even predictive information of commodity flows before and as they happen is invaluable to market participants. The effect of global warming is widely believed to have resulted in extreme weather conditions and patterns and this trend is likely to continue and worsen. Extreme weather conditions can have a real and measurable impact on commodity flows but presently no systems exist that can capture this and other data to monitor and predict the effect of weather on commodity flows.

There are known methods for measuring and obtaining flow related data, including for example the flow or metering of energy commodities and products. For example, GB 0919709 & PCT/EP2010/067281, entitled “A METHOD AND APPARATUS FOR THE MEASUREMENT OF FLOW IN GAS OR OIL PIPES”, U.S. Prov. App. Nos. 60/973,046 and 60/976,946, and PCT App. EP2008/061997 (Published Application WO 2009/037163) and, U.S. patent application Ser. No. 12/678,272 (published application U.S. 2011/0010118), the contents of each of which are incorporated by reference herein in the entirety, describe sub-component monitoring equipment and systems for delivering input supply data. In addition, U.S. patent application Ser. No. 13/423,127, filed Mar. 16, 2012, and entitled METHOD AND SYSTEMS FOR RISK MINING AND FOR GENERATING ENTITY RISK PROFILES (Leidner et. al.)(Attorney Docket No. 113027.000076US1), a continuation-in-part of U.S. patent application Ser. No. 12/628,426, filed Dec. 1, 2009, and entitled METHOD AND APPARATUS FOR RISK MINING (Leidner et. al.), both of which are incorporated by reference herein in their entirety, describe linguistic and other techniques for mining or extracting information from documents and sources.

Even though there is much relevant data around the world relating to shipments, vessels, cargo, commodity pricing, manifest, IMO data, PIERS data, exactEarth data, FOIA obtained data, port inspection data, tender data, etc. The ability to access such far flung data is difficult and the substance of the information inconsistent depending on commodity classification scheme, entity naming and resolution, country and region. Also, even if an entity had a representative in each relevant port/country/station the information is stale by the time it reaches analysts in need of the information.

Several companies and organizations provide vessel and movement data with map visualisation, such entities and resources include: IHS Fairplay (e.g., Lloyds Register), www.AISLive.com, AXS Marine, www.marinetraffic.com, www.vesseltrack.com, www.ExactEarth.com, www.shipais.com (a UK enthusiast ship spotter site), and Automatic Identification System (AIS). AIS is required to be installed on all commercial vessels over 300 tons and passenger vessels and increasingly other types of vessels to broadcast vessel detail including the ID (IMO no.) and name, type, position, speed, heading and navigational status with GPS accuracy. Shore stations and satellites receive the signal, which in turn is the foundation for the datasets available from a range of vendors. Any combination of these and other resources are available for vessel descriptive data and some fixture information. Market participants involved directly with ships, logistics and ship broking as well as commodity market traders benefit from live information on vessels and voyages. Updating information about vessel departures, headings, destination changes and arrivals is vital to commodity market participants in particular estimating physical commodity movements in advance of official aggregated trade statistics.

Division of the world's oceans and waterways may be made based on maritime zone, port and/or berth polygon, which may be customized by a user. While resources exist that provide some level of destination and estimated time of arrival (“ETA”) for final destination broadcast by vessel, the resources are not robust, complete or fully accurate. Vessel ETA is essential information used to determine supply quantities at a destination within certain time periods. The existing resources do not include factors that can influence actual arrival and unloading, e.g., weather, port congestion, deliberate delay in arrival to optimize market value of cargo, etc., and cannot forecast arrival for predictive flows.

Some resources identify the type and tonnage of a vessel as well as its laden/un-laden status. Although one can make an assumption of the cargo carried and, for example, thereby infer shipments, e.g., energy, fuel oil, this is too simple and unreliable as it only identifies probable cargo and quantity and may or may not include any known quality grade related to the shipment, e.g., fuel oil grade. Inferred energy shipments may be aggregated, e.g., by maritime and/or custom zones at a given time using vessel heading and ETA. Knowing the total aggregate supply/demand balance of a commodity in a certain time period is a key input to pricing and give traders an advantage. However, basing decisions on the simple inferred cargo and aggregate commodity flow into a zone is too simple and may lead to costly errors.

Vendors (“shippers”) supply goods to manufactures and/or service providers (“consignees”), which in turn become vendors delivering goods and/or services to further parties. The relationship of goods, often in the form of commodities, and the shippers and consignees forms a supply chain. One method of representing such a supply chain is in the form of a supply chain graph. Companies often lack an explicit graph representation of their own supply chain. Companies may lack sufficient data on incoming vendor and outgoing customer relationships to form a supply chain graph. Additionally, often such supply chain information is a closely guarded company secret, making such data inaccessible to third parties. A company would greatly benefit from knowing its competitors' supply chain information. Access to competitors' supply chain information allows a company to generate a supply chain representation or graph to illustrate and convey a robust and comprehensive understanding of current market risks and opportunities. Analysts can use supply chain graphs to better understand risk exposure implied in a given supply chain. For example, if Apple Corporation relies on lithium batteries to power its mobile computing devices, then a lack of lithium production in the mines where the element originates could lead to a bottleneck in Apple's product supplies, leading to revenue loss, and it could lead to the market price for lithium going up, thus cutting into the margin of devices sold. Both of these effects could directly or indirectly lead to a loss of profits for Apple and its shareholders as well as component suppliers.

Currently, in the context of supply chain management risk alerts with respect to entities and activities are known but are largely untimely and ineffective. Although companies may have access to internal data for the use in generating supply chain graphs for activities within the company, there is currently no effective process for accessing and analyzing data sources or utilities that a company can use to obtain or generate competitors' supply chain graphs. While data is available which may help a company assess current market risks and conditions, a complete and readily accessible data set is not available for a company wishing to analyze the supply chains of other companies. Also, there is no mechanism to arrive at a comprehensive supply chain representation across an industry or other select grouping of concerns. In order to perform a meaningful assessment of current and future market conditions, it is often necessary to compile not only sufficient information, but information of the proper type to formulate an accurate judgment as to whether the information constitutes a risk. Without the ability to access and assimilate a variety of different information sources, and particularly from a sufficient number and type of information sources, into a complete supply chain graph, the identification, assessment and communication of potential risks is significantly hampered. Currently, gathering of supply chain information is performed manually, resulting in inefficiencies and delays, and lacks defined criteria and processes for mining meaningful information to provide a clear picture of the supply chains of others in the market. The invention relates broadly to supply chain visual representations (“visualizations”). For purposes of explaining the applications of the invention in the discussion herein uses the term “graph” as illustrative of a common and preferred form of visual representation. However, the invention is not limited to graphical representation.

As a result of the growing and divergent sources of supply chain information, there is far more information available for creating supply chain visualizations, however manual processing of documents and the content therein is not possible or desirable. Accordingly, there exists a growing need to collect and store, identify, track, classify and catalogue, and process this growing sea of supply chain information/content and to deliver value added service to facilitate informed use of the data and predictive patterns derived from such supply chain information. Due to the development and widespread deployment of and accessibility to high speed networks, e.g., Internet, there exists a growing need to adequately and efficiently process the growing volume of content available on such networks to assist in decision making. In particular the need exists to quickly process information pertaining to supplier/commodity/customer relationships and events that may have an impact (positive or negative) on such relationships and commodity availability and flow so as to enable informed decision making in light of the effect of events and performance, including predicting the effect such events may have on pricing and availability of commodities in a supply chain.

In many areas and industries, including financial services sector, for example, there are content and enhanced experience providers, such as The Thomson Reuters Corporation, Wall Street Journal, Dow Jones News Service, Bloomberg, Financial News, Financial Times, News Corporation, Zawya, and New York Times. Such providers identify, collect, analyze and process key data for use in generating content, such as reports and articles, for consumption by professionals and others involved in the respective industries, e.g., financial consultants and investors. In one manner of content delivery, these financial news services provide financial news feeds, both in real-time and in archive, that include articles and other reports that address the occurrence of recent events that are of interest to investors. Many of these articles and reports, and of course the underlying events, may have a measureable impact on the pricing and availability of commodities. For example, a company may issue a press release that it (as supplier) has entered into an agreement with an other company (customer) to supply that company with a certain quantity of commodities, goods, or services (commodity). Professionals and providers in the various sectors and industries continue to look for ways to enhance content, data and services provided to subscribers, clients and other customers and for ways to distinguish over the competition. Such providers strive to create and provide enhance tools, including search and visualization tools, to enable clients to more efficiently and effectively process information and make informed decisions.

Advances in technology, including database mining and management, search engines, linguistic recognition and modeling, provide increasingly sophisticated approaches to searching and processing vast amounts of data and documents, e.g., database of news articles, financial reports, blogs, SEC and other required corporate disclosures, legal decisions, statutes, laws, and regulations, that may affect business performance, including pricing and availability of commodities. Investment and other financial professionals and other users increasingly rely on mathematical models and algorithms in making professional and business determinations. Especially in the area of investing, systems that provide faster access to and processing of (accurate) news and other information related to corporate operations performance will be a highly valued tool of the professional and will lead to more informed, and more successful, decision making. Information technology and in particular information extraction (IE) are areas experiencing significant growth to assist interested parties to harness the vast amounts of information accessible through pay-for-services or freely available such as via the Internet.

Many financial services providers use “news analysis” or “news analytics,” which refer to a broad field encompassing and related to information retrieval, machine learning, statistical learning theory, network theory, and collaborative filtering, to provide enhanced services to subscribers and customers. News analytics includes the set of techniques, formulas, and statistics and related tools and metrics used to digest, summarize, classify and otherwise analyze sources of information, often public “news” information. An exemplary use of news analytics is a system that digests, i.e., reads and classifies, financial information to determine market impact related to such information while normalizing the data for other effects. News analysis refers to measuring and analyzing various qualitative and quantitative attributes of textual news stories, such as that appear in formal text-based articles and in less formal delivery such as blogs and other online vehicles. More particularly, the present invention concerns analysis in the context of electronic content. Expressing, or representing, news stories as “numbers” or other data points enables systems to transform traditional information expressions into more readily analyzable mathematical and statistical expressions and further into useful data structures and other work product. News analysis techniques and metrics may be used in the context of finance and more particularly in the context of investment performance—past and predictive.

News analytics systems may be used to measure and predict: volatility of commodity pricing and volatility and effects on markets; reversals of news impact; the relevance of risk-related words in annual reports for predicting negative or positive impact; and the impact of news stories on commodities. News analytics often views information at three levels or layers: text, content, and context. Many efforts focus on the first layer—text, i.e., text-based engines/applications process the raw text components of news, i.e., words, phrases, document titles, etc. Text may be converted or leveraged into additional information and irrelevant text may be discarded, thereby condensing it into information with higher relevance/usefulness. The second layer, content, represents the enrichment of text with higher meaning and significance embossed with, e.g., quality and veracity characteristics capable of being further exploited by analytics. Text may be divided into “fact” or “opinion” expressions. The third layer of news analytics—context, refers to connectedness or relatedness between information items. Context may also refer to the network relationships of news.

There are known methods for the preprocessing of data, entity extraction, entity linking, indexing of data, and for indexing ontologies. For example U.S. Pat. No. 7,333,966, entitled “SYSTEMS, METHODS, AND SOFTWARE FOR HYPERLINKING NAMES” (Attorney Docket No. 113027.000042US1), U.S. Pat. Pub. 2009/0198678, entitled “SYSTEMS, METHODS, AND SOFTWARE FOR ENTITY RELATIONSHIP RESOLUTION” (Attorney Docket No. 113027.000053US1), U.S. patent application Ser. No. 12/553,013, entitled “SYSTEMS, METHODS, AND SOFTWARE FOR QUESTION-BASED SENTIMENT ANALYSIS AND SUMMARIZATION” (Attorney Docket No. 113027.000056US1), U.S. Pat. Pub. 2009/0327115, entitled “FINANCIAL EVENT AND RELATIONSHIP EXTRACTION” (Attorney Docket No. 113027.000058US2), and U.S. Pat. Pub. 2009/0222395, entitled “ENTITY, EVENT, AND RELATIONSHIP EXTRACTION” (Attorney Docket No. 113027.000060US1), the contents of each of which are incorporated herein by reference herein in their entirety, describe systems, methods and software for the preprocessing of data, entity extraction, entity linking, indexing of data, and for indexing ontologies in addition to linguistic and other techniques for mining or extracting information from documents and sources.

What is needed is a system capable of automatically processing, parsing, or “reading” news stories, press releases, regulatory and other filings, and other content and sources of information available to it and quickly interpreting the content to identify individual data elements necessary to automatically generate a complete supply chain visualization. Presently, there exists a need to utilize and leverage media and other sources of entity information and a need for advanced analytics relevant to corporate performance, commodity availability and price behavior, investing, and awareness to generate supply chain visualizations. Given the vast amount of news, legal, regulatory and other entity-related information based on text, content and context, investors, corporations, and those involved in financial services have a persistent need and desire for an understanding of how such vast amounts of information, even processed information, relates to the movement of goods, services, and other commodities through supply chains of markets, industries, companies and competitors.

### SUMMARY OF THE INVENTION

We have recognized the need for a system that pulls together remote and various sources of shipping, transport, tender, pricing, supply, demand and other data for presentment to interested parties and that can leverage business intelligence with such data and supplemental data (weather, political turmoil, regulatory requirements, etc.). Also, a system is needed that can process such information and identify predictive patterns or behavior to assist business analysts.

We further recognized the need for a system that based on the generated discrete commodity flows will discover and maintain a model of the global supply chain graph. With such network data structure in place analysis can be executed to simulate the effect on the network from a risk event occurring at a particular node and forecast its likely propagation through the network to understand how supply, demand and price changes may influence other nodes. Similarly, once a risk event has occurred interested parties can assess the impact through the network to most appropriately re-distribute risk, forecast and manage recovery.

To address the short comings of existing systems and to satisfy the present and long felt need in the marketplace, the present invention provides users with enhanced data, analytics and business intelligence as tools and resources in performing business functions. For example, the present invention may be used to identify and track supply/demand relationships and resulting commodity flows between entities in near real-time. Preferably, data collected includes quantities and qualities (or grades) of the commodity. By providing interested users, such as business/investment analysts, with near real-time information concerning the flow of commodities (or disruption in the flow, e.g., embargoes or pirates hijacking oil cargo ship en route to destination) in a global supply chain, the system empowers the users to make informed decisions.

The present invention may also be used to predict a commercial value or other indication of price relative to the identified and monitored commodity flows, which may, but not necessarily, further involve predictions of commodity market prices. The commodity flow intelligence may be used to predict supply or pricing issues in related industries. For example, if the system identifies a shortage in supply (commodity flow) related to a natural resource critical to the manufacture of a finished product. Price forecasting typically is expressed by multi-factor models that include supply and demand quantity inputs as well as other factors and in the context of the present invention may include commodity flow data and intelligence. Often in such pricing models, physical, real-world supply and demand commodity flows are assumed, but not understood largely because the multi-tiered interconnectedness was not previously available as a structured dataset on which analysis can be executed. Such models may include commodity flows that are not tracked and quantified in near real-time and not detailed between supplying and receiving entities, but rather based on an aggregate country-level data collected through monthly or annual trade statistics. The present invention provides a much more detailed and structured dataset based on actual commodities flows in near real-time and the interconnectedness into related industries, which, among other uses, can be input to models to outperform existing price forecasting methods for example the performance of an equity in a company with a dependency on the supply and price stability of a commodity. Also, events associated with risk factors (and their taxonomy) affecting commodity flows and supply chain relationships may be part of system modeling.

The invention provides a computer-based system and method that anticipates (based on data collected in a tender database) possible future supply based on indications of demand. The system/method also substantiates (based on a tender becoming contract and a fixture) agreed contract by inferring the link to a tender. The system/method tracks (based on a content set with AIS and GPS identification, i.e., space, time and identification) the vessel with the inferred shipment. The system/method confirms (based on import/export data, e.g., obtained via U.S. Border Agency) contents/cargo on the vessel down to the level of original shipper and consignee entities. The system/method determines commodity flows in near-real time to establish and render visual/virtual representations of supply and demand balances. The system/method provides insight into the flows behind supply and demand balance and how these flows in turn influence price. Forecasting prices however is a separate related activity directly influenced by the commodity flow supply and demand imbalance insights.

In one manner, the invention may include a Port or Berth Profile function. This allows the system to generate and maintain a profile based on historic verified shipments arriving at Ports and Berths, i.e., a profile of the types of cargo entering and leaving is built up. By basing the profile on actual commodity flows the invention is more accurate than prior resources. The GSCI system may also generate vessel, cargo and/or route profiles, which when combined serve to increase accuracy of forecast flows in conjunction with or in the absence of tenders and/or fixtures.

Weather, global warming and extreme weather conditions and other natural phenomenon, strike action and political events, e.g., governmental change, civil war, are important factors, among others, that influence supply and demand. While the present invention as described herein addresses these concerns, the invention is not limited to these further considerations. With respect to risk mining overlaid onto the supply chain landscape, typical risk considerations may be taken into account along with including other considerations, such as “black swan” types of risks and occurrences.

The term “commodity” as used in the present invention refers to any resources, materials, metals, minerals, energy, goods or services that may be supplied, delivered, traded, bartered, or exchanged to satisfy an individual, corporations, or industry's needs or wants. More specifically, a commodity may be any good that is actively traded in a spot or derivative market including, but not limited to, the Chicago Board of Trade (“CBOT”), Chicago Mercantile Exchange (“CME”), HoustonStreet Exchange, Intercontinental Exchange (“ICE”), Kansas City Board of Trade (“KCBT”), Nadex Exchange, New York Mercantile Exchange (“NYMEX”), and U.S. Futures Exchange (“USFE”). As used herein, commodity may refer to resources, industrial products, components, and agricultural products such as iron ore, crude oil, natural gas, diesel fuel, gasoline, ethanol, industrial chemicals, computer chips, coal, salt, sugar, tea, coffee beans, soybeans, aluminum, copper, rice, wheat, gold, silver, palladium, and platinum. Commodity as used herein may also refer to manufactured products, finished products, or services manufactured or provided by a first company and sold or provided to an other company for the purpose of the further manufacture of goods or provision of services.

In a first embodiment, the present invention provides an automated computer-implemented method comprising: (a) accessing a first set of information relating to a set of transportation vehicles, the first set of information including a first set of location data associated with the set of transportation vehicles at a first time and associated with a first journey, the first journey being in the present and not a previously completed journey; (b) accessing a second set of information relating to the set of transportation vehicles, the second set of information including a second set of location data associated with the set of transportation vehicles at a second time and associated with the first journey, the second time being different than the first time; (c) accessing a third set of information relating to the set of transportation vehicles, the third set of information including unique transportation vehicle identification data associated with the set of transportation vehicles; (d) accessing a fourth set of information relating to the set of transportation vehicles, the fourth set of information including a set of actual transaction data associated with a set of cargo types actually present on and being transported by the set of transportation vehicles during the first journey, the set of actual transaction data comprising data from at least one of the group consisting of: tender data; fixture data; and port inspection data; (e) forecasting a set of tasks relating to the set of transportation vehicles and the set of cargo types, the set of tasks corresponding with the set of transportation vehicles, the set of tasks being based at least in part upon the first set of information, the second set of information, the third set of information, and the fourth set of information; and (f) based upon the set of tasks, generating a set of financial information relating to the set of cargo types.

In a second embodiment, the present invention provides a computer-based system having a server comprising a processor adapted to execute code and a memory for storing executable code. The system includes an input adapted to receive a set of information derived from a set of information sources. The system includes a first set of code when executed by the processor being adapted to automatically access a first set of information relating to a first set of locations of a set of transportation vehicles, the first set of locations being of the set of transportation vehicles at a first time and associated with a first journey, the first journey being in the present and not a previously completed journey. The system includes a second set of code when executed by the processor being adapted to automatically access a second set of information relating to a second set of locations of the set of transportation vehicles, the second set of locations being of the set of transportation vehicles at a second time and associated with the first journey. The system includes a third set of code when executed by the processor being adapted to automatically access a third set of information relating the set of transportation vehicles, the third set of information being related to a set of unique transportation vehicle identifiers. The system includes a fourth set of code when executed by the processor being adapted to automatically access a fourth set of information relating to the set of transportation vehicles, the fourth set of information including a set of actual transaction data associated with a set of cargo types actually present on and being transported by the set of transportation vehicles during the first journey, the set of actual transaction data comprising data from at least one of the group consisting of: tender data; fixture data; and port inspection data. The system includes a fifth set of code when executed by the processor being adapted to automatically forecast a set of tasks relating to the set of transportation vehicles and the set of cargo types, the set of tasks corresponding with the set of transportation vehicles, the set of tasks being based at least in part upon the first set of information, the second set of information, the third set of information, and the fourth set of information. The system includes a sixth set of code when executed by the processor being adapted to automatically, based upon the set of tasks, generate a set of financial information relating to the set of cargo types and to store the set of financial information in the memory. The system includes an output adapted to transmit a signal associated with the generated set of financial information.

In a third embodiment, the present invention provides a computer-based system comprising: a server comprising a processor adapted to execute code and a memory for storing executable code; an input adapted to receive a set of information derived from a set of information sources, the set of information including two or more data types from the group consisting of: transportation vehicle identification data; transportation vehicle location data; tender data; fixture data; cargo data; destination data; load data; charterer data; seller data; buyer data; issuer data; cargo pricing data; arrival date data; departure date data; a user interface executed by the processor to present a commodity flow screen comprised of a plurality of data entry items, the user interface comprising; a vehicle location module when executed by the processor being adapted to automatically determine a first set of locations associated with a first transportation vehicle; a commodity flow module when executed by the processor being adapted to present a commodity flow screen and to process user inputs received via data entry items included in the commodity flow screen and being further adapted to store in the memory a first commodity flow record comprised of received user input data, the first commodity flow record being associated with a first transportation vehicle and a cargo carried by the first transportation vehicle; a forecast module executed by the processor to automatically forecast a set of information relating to the first commodity flow record and to generate a set of financial information relating to the cargo and to store the set of financial information in the memory; and an output adapted to transmit a signal associated with the generated set of financial information.

In a fourth embodiment, the present invention provides a system comprising: a processor; a memory communicatively coupled to the processor; a program stored in the memory, the program comprising: an input and identification module (“IAIM”) for permitting the receipt of a set of information, the IAIM comprising executable code adapted to determine whether the set of information contains data related to one or more of a supplier, a commodity, and a customer; and an instantiated query generation module (“IQGM”) communicatively coupled to the IAIM for generating a query comprising a supplier entry, a commodity entry, and a customer entry, the IQGM comprising a placeholder generation module for inserting a placeholder into the query for one or more of: the supplier entry if the IAIM determines a supplier absence in the set of information; the commodity entry if the IAIM determines a commodity absence in the set of information; and the customer entry if the IAIM determines a customer absence in the set of information; a transceiver for sending the query and receiving a set of supply chain information; a supply chain generation module for generating a supply chain data structure based at least in part upon the set of supply chain information; and a transmitter for transmitting a signal comprising the supply chain data structure.

In a fifth embodiment, the present invention provides a computer implemented method comprising: receiving by a computer a set of information; identifying by a computer one or more of a supplier, a commodity, and a customer from the set of information; generating by a computer an instantiated query comprising a supplier entry, a commodity entry, and a customer entry corresponding, respectively, to the identified supplier, commodity, and customer in the set of information; determining by a computer the absence of any of a supplier, a commodity, or a customer from the set of information and generating and inserting a placeholder for each item absent from the set of information; sending by a computer the query; receiving by a computer a set of supply chain information; generating by a computer a supply chain data structure based at least in part upon the received set of supply chain information; and transmitting by a computer the supply chain data structure.

In a sixth embodiment, the present invention provides a system comprising: a server comprising a processor adapted to execute code and a memory for storing executable code; an input adapted to receive a set of information over a communication network, the set of information derived from one or more remote data sources, the set of information including structured and unstructured data; a user interface executed by the processor to generate a supply chain visualization screen signal comprised of a plurality of data items, the user interface comprising: an input and identification module (“IAIM”) when executed by the processor being adapted to permit the receipt of a set of information, the IAIM comprising executable code adapted to determine whether the set of information contains data related to a supplier, a commodity, and a customer, respectively; and an instantiated query generation module (“IQGM”) communicatively coupled to the IAIM when executed by the processor being adapted to generate a query comprising a supplier entry, a commodity entry, and a customer entry, the IQGM comprising a placeholder generation module when executed by the processor being adapted to insert a placeholder into the query for one or more of: the supplier entry if the IAIM when executed by the processor determines a supplier absence in the set of information; the commodity entry if the IAIM when executed by the processor determines a commodity absence in the set of information; and the customer entry if the IAIM when executed by the processor determines a customer absence in the set of information; a transceiver being adapted to sending the query and receiving a set of supply chain information; a supply chain generation module when executed by the processor being adapted to generating a supply data structure based upon the set of supply chain information; and a transmitter being adapted to transmitting the supply chain data structure.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is a block diagram illustrating one embodiment of a Global Supply Chain Intelligence (GSCI) system architecture according to the present invention;

FIG. 2 is a flow chart illustrating a method for obtaining information related to a set of transportation vehicles and generating a forecasted set of tasks according to the invention;

FIG. 3 is a flow chart illustrating a method for creating profiles and indicia representing predicted behavior according to the invention;

FIGS. 4A and 4B collectively depict a schematic diagram of an embodiment of the GSCI according to the invention;

FIGS. 5A and 5B collectively depict a schematic diagram of another embodiment of the GSCI according to the invention;

FIG. 6 is a schematic diagram of a client-server architecture for providing the GSCI according to the present invention;

FIGS. 7-10 illustrate exemplary screen shots and user interface elements associated with delivering a service associated with the GSCI of the present invention;

FIGS. 11-15 illustrate exemplary screen shots and user interface elements associated with commodity flows associated with the GSCI of the present invention;

FIGS. 16-27 illustrate exemplary screen shots and user interface elements associated with commodity flow editorial function associated with the GSCI of the present invention;

FIGS. 28 through 30 illustrate three exemplary embodiments of supply chain graphs generated in accordance with the present invention;

FIG. 31 is a schematic diagram of a client-server architecture for providing the SCG system according to the present invention;

FIG. 32 is a schematic of a device for generating a supply chain visualization according to the invention;

FIG. 33 is a schematic diagram of an alternate embodiment of a device for generating a supply chain visualization according to the invention;

FIG. 34 is a flowchart depicting a process for generating a supply chain visualization according to the invention;

FIG. 35 is a flowchart depicting an alternate embodiment of a process for generating a supply chain visualization according to the invention;

FIG. 36 is a depiction of sets of triples to be used for the generation of a supply chain visualization according to the invention; and

FIGS. 37 and 38 depict exemplary embodiments of supply chain visualizations generated according to the invention.

### DETAILED DESCRIPTION OF THE INVENTION

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

The invention provides a Global Supply Chain Intelligence system (“GSCI”) adapted to predict, discover and verify commodity trade flows. The invention provides methods for creating a dataset that tracks real and near real-time commodity flows as they happen as an input to the GSCI. The dataset may also be used in a business intelligence process within the GSCI to arrive at an output, such as a predicted price behavior, a price alert, a risk alert, etc. In one manner the GSCI includes a Commodity Flow Intelligence (CFI) component that collects and analyzes information with the timeliness, detail and accuracy required to track, forecast and predict supply and demand imbalances at the discrete flow level to aid market participants in making operational trading and investment decisions. The GSCI may be used, for example, in connection with a financial services system or offering such as Thomson Reuters Eikon and Point Carbon services and products to provide users enhanced data and tools and to promote market transparency, especially for concerns lacking internal resources to collect and analyze such global data on their own. For larger concerns the GSCI provides enhanced services and reduces the cost associated with supply chain analysis and risk management.

The GSCI preferably optimizes vessel descriptive data and movement data using specialized data model and combination of internal and external database(s) of records of physical assets. For example, in the context of one proprietary environment, that of Thomson Reuters, vessels are coded with IMO number and an RIC to therein relate news and other content and data in Eikon. Employing the GSCI in a proprietary and comprehensive suite of content products and services, the invention facilitates adding features that allow modeling of physical fundamentals and financial information. As described in detail below, the GSCI preferably provides a map visualization user interface (UI) design and implementation, e.g., integrated with Eikon search and the ability to cross reference related news and data. In this way a user may build a montage of interrelated information for example to monitor a set of physical infrastructures involved with the extraction, processing, transportation and storage of crude oil and oil distillates e.g. fuel oil. The montage can further incorporate news and price information related to the physical infrastructures as well as the listed stock of the operator and owner companies involved, current and historical market prices of the related commodities and company stock. The collective related information from the montage can further serve as inputs to a multi-factor pricing model that takes into account real and near real-time commodity flows and interruptions to these as a result of risk events as well as the ongoing developments in supply/demand imbalances. These improvements are largely achieved through the comprehensive and consistent entity resolution and coding process applied onto diverse datasets, such as by applying proprietary, e.g., Thomson Reuters, taxonomies and reference data coding schemes.

In the context of Eikon, a user is presented with commodity flow records and information via user interface screens presented by an information desktop application. The user may navigate using, for example, an index to asset classes and from this may select commodity as an asset class and then dig deeper into particular commodity types. Using this user interface, the user may create, maintain and modify commodity flows and link to content, tools and resources related to such commodity flows. By bringing together data obtained from both internal and external sources, leveraging business intelligence applied to such data, linking resources, and presenting the data and enhancements via a single desktop application or web interface, the system provides users a “one stop shopping” experience. To this end, the system may also provide a common access point allowing users to enter a single set of login information to open access to a range of products and services.

In one example, the CFI of the GSCI includes modules for commodities such as fuel oil, crude oil and LNG (Liquefied Natural Gas) and provides modeling of the global supply chain associated with such commodities. Information and services provided by the CFI may be leveraged across different markets and businesses. The present invention may be configured to provide, for example, three components: 1) a computer-implemented method to extract discrete commodity flows from multiple data sets accurately and in near-real time; 2) a method to predict commodity flows; and 3) one or more systems to search, compartmentalize, map, alert, analyze, simulate, risk assess, etc., commodity flows in order to inform supply and demand for trading and investment decisions not just in the upstream financial services realm or supply chain, but all the way out into the manufacturing, services and retail sectors. For example, a manufacturer concerned with a steady supply of raw materials necessary in the manufacturing process to produce a finished product for retail sale.

The CFI includes discrete areas of commodity flow monitoring and reporting. For example, the CFI includes a Fuel Oil Module (FOM) that receives and processes commodity data related to fuel oil and a Crude Oil Module (COM) that receives and processes commodity data related to crude oil. Two types of data received and processed by the modules are: supply data (e.g., business analysts); and demand data (e.g., government/customs data). Demand data may include: proprietary data (e.g., gathered and distributed by Thomson Reuters business analysts and services); individual flows; user interface; aggregate flows and history; text commentary; and dynamic metastock charts of aggregates (e.g., (Reuters Instrument Code) RIC-based data). Proprietary data may include: tender information; and fixture information. As used herein, “tender” refers to generally to an offer or request for provisioning of needed items and more particularly to an auction process in which a consumer (issuer/buyer) issues or publishes in tender a need for supply of a commodity and a set of suppliers bid to supply the needed item(s) with a contract awarded to a successful supplier/bidder (seller) or a request for quote for a certain commodity, quantity, purchaser and time period that becomes a contract or is cancelled. The term “fixture” refers to an agreed shipment using an agreed vessel and represents contracts to charter a vessel on a time or voyage basis to transport the cargo, e.g., commodity, from a source to a destination. Neither tender nor fixture should be limited to the context of commodity agreements. Individual flows data includes, for example, data related to vessel movements, arrivals, departures (AXS Marine) and cargo data from tenders & fixtures. A user interface is provided to present summary data (e.g., an overview), “Flows Explorer” comprising: aggregated data tables and charts, and a search facility; and detailed flow data for data verification. “Grades” data cleanse provides enhanced understanding and representation of the grade(s) of fuel oil or crude oil comprising the cargo.

Customs and port inspection data include import and export data such as the cargo, commodity, quantity/value and shipper/consignee parties to the consignment. This data may be used to maintain port profile records, confirm forecast patterns, establish a history of flows through ports, and determine the counter-parties to individual cargoes.

Examples of data and sources of data related to cargo include PIERS and other port inspections data. PIERS (“Port Import Export Reporting Service”) is a source of historical import and export information on cargoes moving through ports in the United States, Latin America and Asia. PIERS represents that it collects data from more than 15,000,000 bills of lading each year representing greater than 20,000,000 shipments annually and converts the collected raw data into cleansed, standardized, enhanced and validated facts and figures. Examples of data collected include: U.S. Customs and Border Protection Automated Manifest System; data collected by PIERS Reporters located at ports throughout the United States and elsewhere; cross border records collected from key-trading partners whose national Customs authorities provides the data; and audits to confirm accuracy of data elements across key bill of lading fields. PIERS data is published daily often available within 24 hours of a ship offloading its cargo in the United States. Flows and commodity flows may refer to energy flows, e.g., energy transmitted and delivered using a power grid, such as electricity, comprising a plurality of power producing plants and distribution system.

The GSCI enables users to generate and monitor commodity flows and includes functions to auto-generate individual flows, such as based on a prior or existing commodity flow involving the same vessel, charterer, seller, buyer, or based on similar fixture or tender terms. The system provides tools and links for efficient verification and publication by analysts. Once created, flows may be distributed or published, for example, in SDI-like (Strategic Data Interface) feeds. Recipients of the commodity flow feeds may apply further analytics and algorithms and the feeds may be tailored, either content or format, to match recipient needs and system requirements.

The intelligence provided by the CFI may be supplemented with additional information sources within the GSCI. For example, weather/disaster related concerns may be processed to further arrive at predictive modeling and risk assessment. For example, the GSCI may collect information concerning a tropical storm forming in the Atlantic Ocean and output information or alerts concerning the current or anticipated status and volume of output from key oil refineries in the Gulf of Mexico and affect on assets such as offshore oil rigs. The GSCI may also track oil tankers heading into a region facing potential storm paths with estimated intensity to predict a potential shortfall in crude supplies. In another example, the GSCI may identify the occurrence of a major earthquake in Chile, a major global supplier of copper, and identify the earthquake as a disturbance or disruption in the supply chain. The GSCI may further identify that copper is in high demand and identify disruption in other products farther down the supply chain, e.g., finished products that require copper. Another example would be a disruption in the supply of tungsten as having a negative effect on the supply of finished products that include tungsten, e.g., semiconductors. The GSCI may predict or “know” that the earthquake has shutdown a significant number of mines in Chile, including the number of mines closed, the total capacity affected, and when the affected mines will potentially re-open. In one other example, the GSCI may collect and analyze other information, e.g., political unrest, civil war, coups, etc., that may affect (positively or negatively) commodity flows and possible supply (and therefore price) issues. The GSCI may include a Fundamentals Risk Factor Classification, Quantitative Scaling and Assessment function adapted to define risk factors affecting fundamentals of supply and demand (e.g., natural phenomenon, political unrest, black swans). The GSCI may provide analytics for risk event impact assessment and recovery dynamics. In this manner, the system provides a vulnerability assessment of Global Supply and Demand. Input factors for abnormal returns (Alpha) may be provided and the system may present a basis for hedging and managing supply/demand risk. By quantifying the value at risk for a client specific supply chain or physical asset the GSCI provides for risk mitigation and asset/investment re-allocation strategies. This enables users to re-evaluate trading strategies and take steps to maximize future profit. In one manner, the GSCI provides users with an interactive map having representations of real-time asset locations, e.g., ships, trains, planes, and related cargo, known or predicted departure/arrival locations, weather, political and other conditions. Historical data may be collected from a variety of sources over time to help establish and refine and train predictive models.

One manner of performance measurement involves fundamentals data concerning physical assets, which quantifies current production and maximum output capacity and other relevant characteristics and operational status of the extraction, production, refinement, storage and the distribution infrastructures involved in the supply chain. The Fundamentals content also includes the many factors and news on natural phenomenon such as weather, logistics and even political events that impact supply and demand, which in turn influences pricing.

The GSCI may apply linguistic analytics and mine data from one or more sources of relevant unstructured information and documents, e.g., company reports. This is especially useful when there are limited data sources available and mining of other content provides a ready source of useful data, e.g., extracting supplier and consumer relationship data. The GSCI may include functionality for risk mining, for example as disclosed in U.S. patent application Ser. No. 13/423,127, filed Mar. 16, 2012, and entitled METHOD AND SYSTEMS FOR RISK MINING AND FOR GENERATING ENTITY RISK PROFILES (Leidner et. al.). In this manner, the GSCI may fill a gap in structured supply chain relationship data by looking for triplets (e.g., supplier, consignee, commodity) in linguistic constructs across various text documents and resources, e.g., Thomson Reuters news file/feed, company reports, and Web-based sources. For example, the GSCI may include code when executed by a processor is adapted to automatically generate a set of risk information, which may include one or more of financial risk; legal risk; operational risk; markets risk; commodities shortage; commodities excess; political risk; weather risk; and sanctions risk. Legal risk, for example, might relate to a commodity flow comprising a departure or source country that is subject to sanctions by the destination or discharge country, e.g., oil sourced in Iran and scheduled for delivery to the United States. Similarly, cargo of particular type, such as a weapon, banned for export may be included on a commodity flow. In this manner, the system may issue an alert to an analyst or to a governmental authority or agent or to a representative of the shipping, selling or buying entity allowing the detection, intervention or prevention of the occurrence of an illegal act. Because structured authoritative supply chain relationship data at the entity level are sparse and where available generally covers only international trade where a customs authority is involved and then primarily only for ocean borne cargo. By incorporating or using text mining functionality, the GSCI complements global supply chain relationship data from known and reliable sources. This is especially valuable for supply chain relationships that do not involve international customs cross border trade.

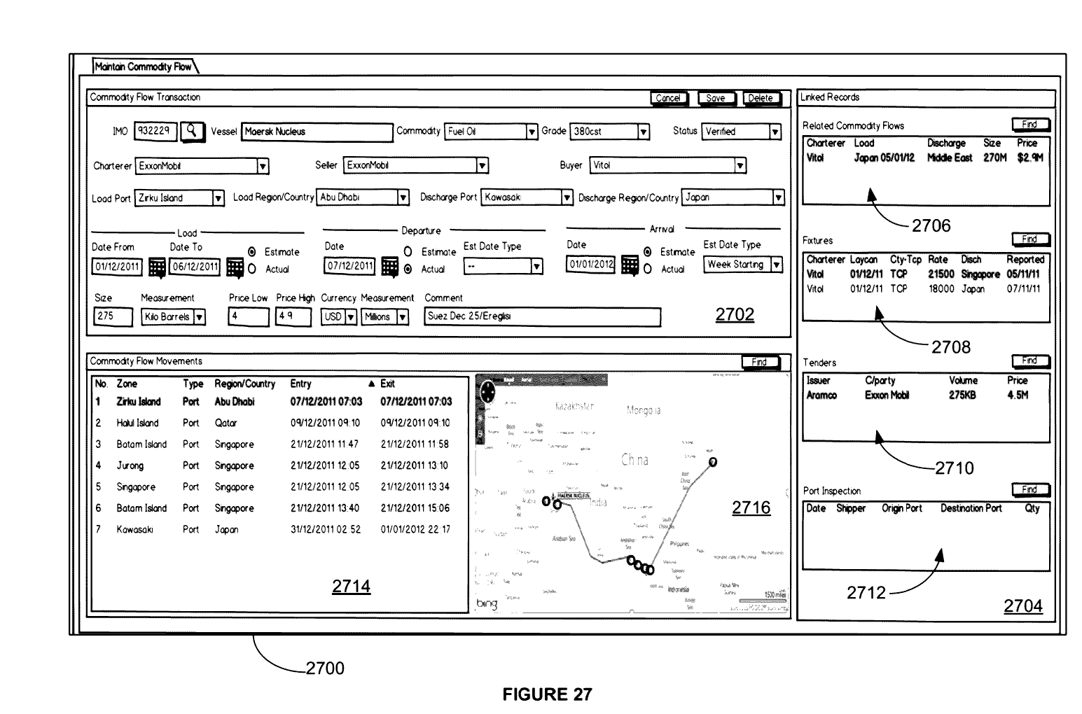

The GSCI may further provide tools for generating supply chain graphs (e.g., see FIGS. 28-30) to depict relationships among the various players, supplier, buyer, seller, etc. Supply chain graphs may be global or local or regional in nature or based on industry or a given entity, e.g., British Petroleum (BP) showing interconnectedness of commodity flows involving BP. In this manner the GSCI enables users to better understand quantified actual supply and demand network relationships. In one variation, the GSCI may provide a temporal supply chain graph. A database of historical supply chain relationships may serve as the foundation for various assessments and simulations. Understanding historical supply and demand network relationships enables users of the GSCI to better assess change and enable predictive analysis of future impact and recovery dynamics.

The GSCI may include a Predictive Model used to forecast shortages, excess supplies, shipments, e.g., energy shipments. For example, with certain types of cargoes such, as Asian Fuel Oil, users may know of future flow through known Tenders. Once a contract between parties is agreed and entered into this will likely result in a Fixture, which is the contract to charter a vessel to carry the commodity from its source to its destination. The GSCI may follow the tender and fixture process and map the tender/fixture to a vessel and its progress. Individual and aggregated flows can be more accurately forecast in advance using shipment inferences based on multiple factors rather than only observed in arrears. Early reliable flow forecasts provide an important factor in forecasting price (for pricing futures, hedges, options).

The GSCI Predictive Model stores profile data for vessels, ports and routes, which can be used in conjunction with commodity flows where the fixture is currently being fulfilled (i.e., Status=“Vessel Underway”), and the vessel location data to aid in predicting discharge destination port, destination arrival date/time, and additional cargo details such as more detailed type of commodity (e.g., crude grade, fuel oil grade, etc). For Vessel Profiles, analysis of the vessel location history may be used to extract and aggregate on origin and destination ports, and to identify average journey times. Connecting this data to events data to ascertain the impact of events, such as hurricanes, on historical journey times, which in turn may be used to assess the impact on current journeys. In addition, Port profiles may be used to identify what cargoes are flowing in and out, and from/to which countries.

In another exemplary use of the present invention, the GSCI is used to more closely associate the relatedness of imports and exports on an industry sector within a country and use this information to make determinations or pricing predictions outside the country or particular commodity. For example, in the past services that collected import/export data could collect oil disclosure in the form of statistical data that's published monthly/annually by country agencies. For example, national publications that China used or exported X tons of A (refined oil) and imported Y tons of B (crude oil). However, this publication only informs in the aggregate and not in real-time as the discrete shipments incoming/outgoing or use are occurring. Accordingly, financial analysts cannot fully use this information. The data needs to be collected in near real-time and needs to be broken down as much as possible. In one simple exemplary scenario, the GSCI collects data and determines that: 1) China imported X tons of crude oil, 2) only used 0.4X tons of refined oil, and 3) therefore, China built up 0.6X tons of crude oil in inventory. A user of the GSCI may then decide (or the GSCI may automatically determine) that: 4) China has excess inventory and 5) predict that the price of crude or refined oil (local or global) may decrease. In the alternative, a determination that a location has too little inventory may lead to a determination that the price of the commodity is likely to rise.

One currently existing problem is that “news” often lags as it relates to the impact evolution of a supply chain event—sometimes by days or weeks—simply because it is complex to know to where the effect will ripple to next. For example, when Japan suffered devastating effects resulting from the March 2011 earthquake and tsunami natural disasters. Although the occurrence of the disaster and devastating human suffering were timely reported, many follow-on effects, including in the area of supply and demand, were not timely reported or even detected. One example of the time lag in cause and effect reporting was in the case of Apple's iPad product. It was not until almost a week following the tsunami event that all the dots were connected and the issue of negative impact on iPad manufacturing and sales reported due to a shortage of key component parts supplied by a company located in Japan and taken out of operation by the tsunami. Had the interconnectedness between iPad sales and the tsunami-affected supplier been detected earlier, then the “news” of this adverse effect on supply/demand could have been more timely published and the financial impact of the supply/demand issue detected and acted upon, such as by financial analysts and investors.

A fundamental premise of the Global Supply Chain Intelligence system is to build a relationship network (interconnectedness) able to anticipate the impact of an event on supply and demand before or immediately after it occurs. Rather than waiting for the impact of an event and subsequent “news” stories as they break over days or even weeks to ripple through the supply chain network, one goal of the GSCI is to detect and quantify the likely paths and impact of events using a model (e.g., based on intelligence and historical knowledge) of the global supply and demand network. In this manner, users of the GSCI system may gain insights helpful in taking preventative steps (e.g., hedging) and quicker reactive actions for recovery as well as identifying abnormal return opportunities through a deeper physical understanding of the supply/demand network dynamics. In the example of the tsunami in Japan, the GSCI could refer to the knowledge of the previously established supply chain relationship between Apple, the iPad product in particular, and Japan-based supplier and the component part in particular. Based on this knowledge, and for instance a supply chain graph associated with one or more of the products and companies, an investor may be provided with an alert or other indication of the predicted supply chain disturbance and is thereby given the opportunity to take appropriate action. Another example is a news report of an impending strike or other labor disruption at a mining operation in Poland that supplies a key natural resource, e.g., tungsten, used as a critical material in producing component parts such as semiconductors. Based on commodity flows and supply chain relationships the GSCI may be used to timely and automatically identify commodity flows related to tungsten, identify existing consumer/supplier relationships, and generate an alert or other signal concerning the potential for an adverse effect on not only the supply of the material (tungsten) but also affected component and end products and affected companies that rely on either the raw material, the component parts, or that sell the finished product.

In one manner, the GSCI may link resources and products to entities (e.g., what does a car manufacture (e.g., Ford) manufacture (e.g., automobiles) and depend on (e.g., steel, energy, labor, component parts) in its operation). Two exemplary expressions of this dependency are 1) Entity X is a Supplier to Y of Commodity Z; and 2) Entity X is a Customer of Supplier Y of Commodity Z. This may yield a quantitative description of supply and demand relationships, monetary values, and/or quantities, resource, material, and energy flows as appropriate. The output may be in the form of a temporal supply and demand relationship reconfiguration dynamics expression. Also, a News Timeline including event progression across time may be generated. Additional outputs may be in the form of or represent: change in capacity, production, flow impacts, stock or value impacts; risk and vulnerability hotspots (geographic, entities, industries, networks); risk scores (geographic, entities, industries, networks)(e.g., measure for a network, sector or resource expressing potential impact and likelihood of occurrence); resiliency scores (geographic, entities, industries, networks)(measure for a networks ability to absorb an event, reconfigure connections/supply chain network and the expected time to recover supply and/or demand); and reconfiguration potential (geographic, entities, industries, networks). By way of example and not limitation, the GSCI may include the following information in supplier/consumer relationship records: how much of the commodity is produced; for what is the commodity used; who supplies the commodity; who uses this commodity; who are the sub processing, manufacturing and inventory entities; how much of this commodity flows to whom; how much energy is used; and how has the use of this commodity changed over time.

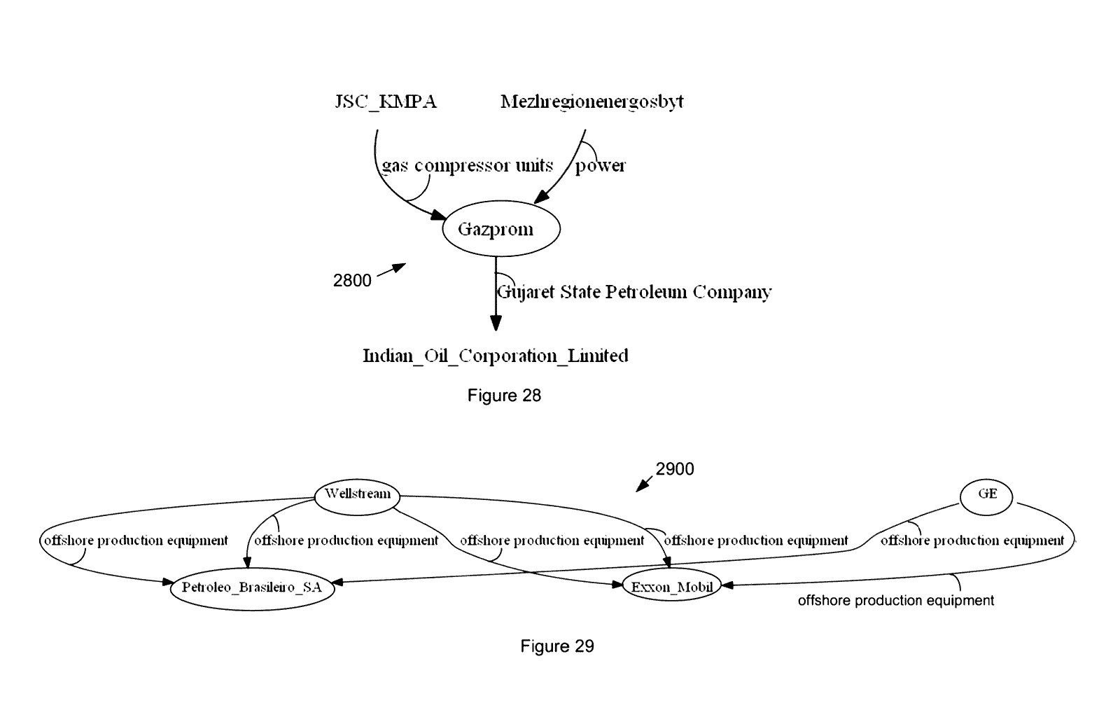

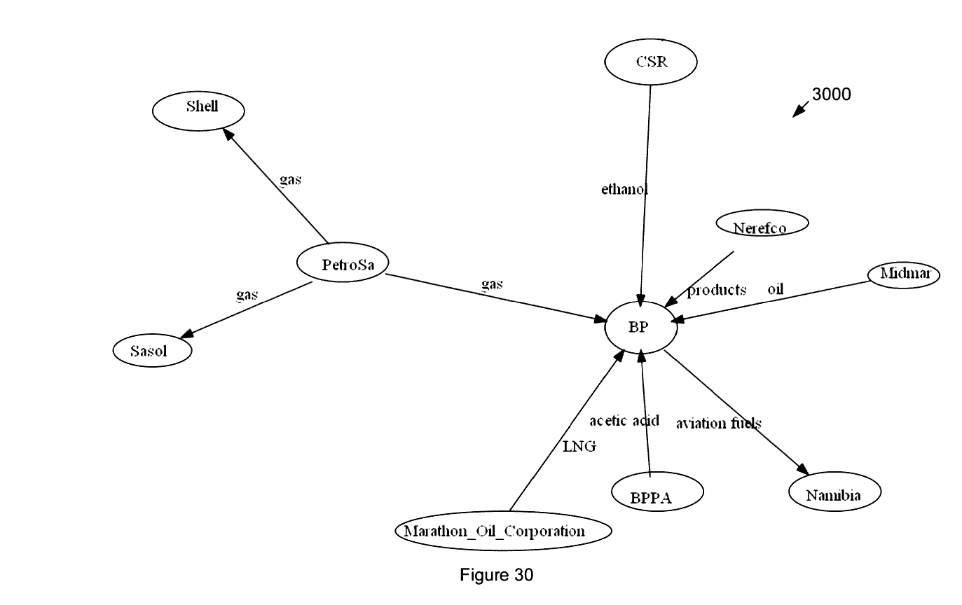

FIGS. 28 through 30 illustrate three exemplary supply chain graphs 2800, 2900, and 3000, respectively. With reference to FIG. 28, supply chain graph 2800 represents a relationship between entities concerning certain equipment and supply/demand connectedness. Here, Gazprom receives as a consumer gas compressor units from supplier JSC KMPA and power from Mezhregionenergosbyt. Gazprom also has a relatedness as a supplier to Gujaret State Petroleum Company and Indian Oil Corporation Limited. With reference to FIG. 29, supply chain graph 2900 represents a relationship between entities and equipment and oil supplies derived from the following excerpt from a news story or a company report or release using linguistic mining techniques described herein: “GE in December targeted Brazil's oil production wealth with a $1.3 billion purchase of U.K.-based Wellstream Holdings PLC. Wellstream supplies offshore production equipment to companies like Exxon Mobil Corp. (NYSE: XOM) and Petroleo Brasileiro SA (NYSE ADR: PBR) that explore the deepwater oil fields off Brazil's coast, estimated to hold up to 20 billion barrels of oil.” The relationship may be further related with various interconnectedness within or across industries. With reference to FIG. 30, supply chain graph 3000 represents a relationship between entities. Here, PetroSa supplies gas to Shell, Sasol and BP. BP has a further relationship as a consumer with suppliers: CSR (ethanol); Nerefco (products); Midmar (oil); Namibia (aviation fuels); BPPA (acetic acid); and Marathon Oil Corporation (LNG).

As discussed above, content may be input into the GSCI system, such as by linguistic analysis (risk mining), and used in predictive modeling and in supply chain graph analysis. However, the reverse may be true as well. For example, a global supply chain graph enables a user to follow supply chain network connections as well as examine past events to predict potential supply chain impact of certain events or occurrences. Taking this one step further, the GSCI' s predictive modeling and supply chain graph analysis may be used to generate content, e.g., in the area of journalism or other reporting. For example, the GSCI may include a content generator that automatically generates news articles (or starts or drafts of articles) or other forms of deliverable content based on detected disturbances or issues in the global supply chain or related to a particular company or industry. An Editor function provides users with tools to quickly prepare story lines early in anticipation of events likely to follow.

In addition to financial services industry and investment or business analysts, manufacturing concerns may likewise be interested in tracking commodity flows and predictive outcomes. For instance, a manufacturing company dependent on the supply of raw materials can use the GSCI to track supply and costs associated with necessary raw materials. The GSCI may be used in connection with an ERP (Enterprise Resource Planning) or ERM (Enterprise Risk Management) system to ensure a flow of materials needed in the manufacturing processes. The GSCI may also be used to anticipate not only availability of raw materials but price swings in such materials to manage cost, ordering and overhead associated with raw materials.

The GSCI may include or connect with a tender database, i.e., a database of entities who can supply requester with X (quantity or volume) of Y (material or commodity) and at Z (price). A ship database represents a registry of ships, such as cargo ships, known to carry and deliver commodities, materials and products of interest. The ship database will contain data related to the registry of the ship, size of the ship, cargo capacity, types of cargo carried by ship, historical data, past routes, past shipments, past fixtures, etc. The GSCI collects data and matches tenders/fixtures with ships to establish data points related to supply and demand and balance or imbalance in the global supply chain of a given material or commodity. The GSCI may further include business intelligence to provide forecasting and predictive outputs, e.g., likely impact on pricing related to a commodity or related product. If an analyst through use of the GSCI can identify or detect a disruption in the supply chain then the analyst can make better informed decisions concerning investments. Similarly, if an internal supply analyst can predict an upcoming shortage in raw materials needed in a manufacturing process, then the company can increase the normal volume of the raw material to increase inventory to avoid plant shutdown or inefficiencies or price/overhead increases.

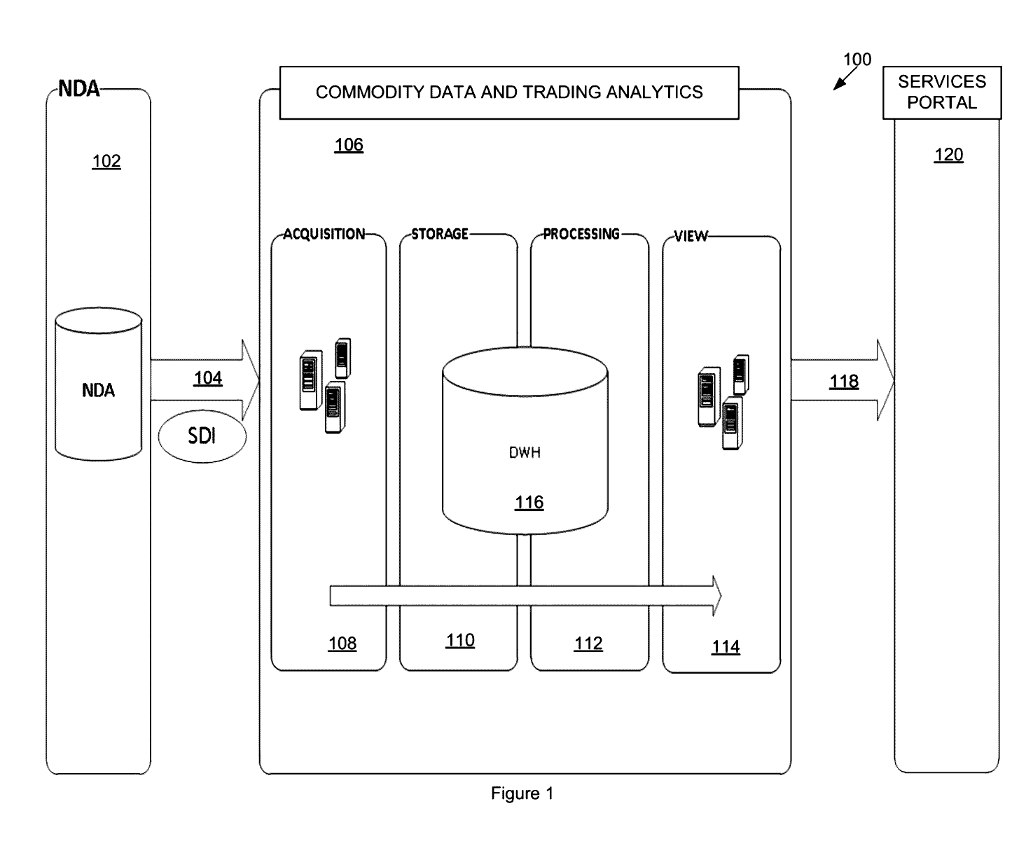

FIG. 1 is a schematic block diagram that illustrates a general overview of the data and processing flow of an exemplary commodity data collection and processing system 100 within the overarching Global Supply Chain Intelligence system (“GSCI”). As shown, system 100 includes NDA 102 (Numeric Database Architecture—back-end infrastructure supporting commodity intelligence products, e.g., Thomson Reuters products). NDA 102 provides an SDI (Strategic Data Interface) feed 104 (e.g., data distributed through FTP uploads as SDI formatted files) to serve data to Commodity Data and Trading Analytics System 106, e.g., Thomson Reuters Point Carbon. The data from NDA 102 relates to the commodity flow application (Flowzone) and in one exemplary manner there are several layers involved in preparing, delivering and processing the Flowzone data within system 106. Known methods for configuring data acquisition/storage/view layers and related schema may be used to most effectively prepare, deliver and store commodity related information for use in system 106. Proper packaging or formatting of external sources of commodities related data may be necessary to insure accuracy of incoming data.

System 106 includes within its architecture and acquisition component 108, a storage component 110, a processing component 112 and a viewing or presentment component 114, which may be referred to collectively as Data Warehouse 116. System 106 generates a commodity data and trading analytics set of feeds 118 that are delivered to financial services portal, e.g., Thomson Reuters EIKON, 120 for further processing and packaging and for delivery to users authorized to access the financial services portal and its proprietary data and analytic tools, such as through view pages. The GSCI may be presented to users as a part of the portal system or via a parallel channel with access to the portal assets.

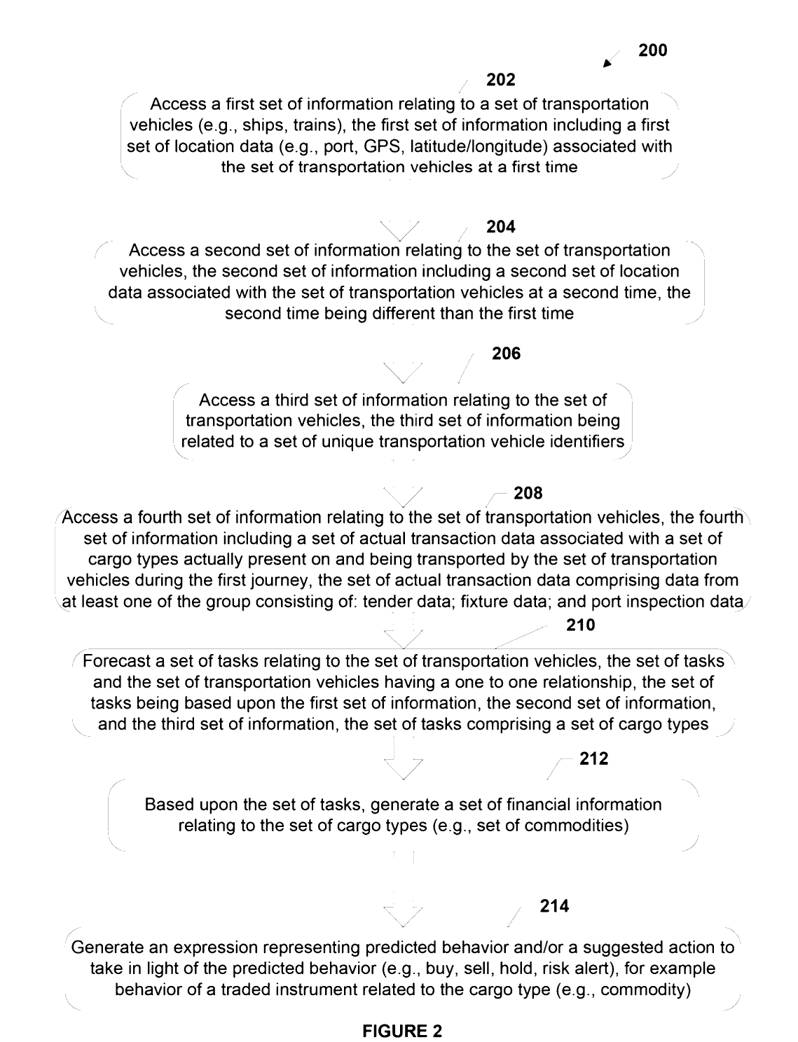

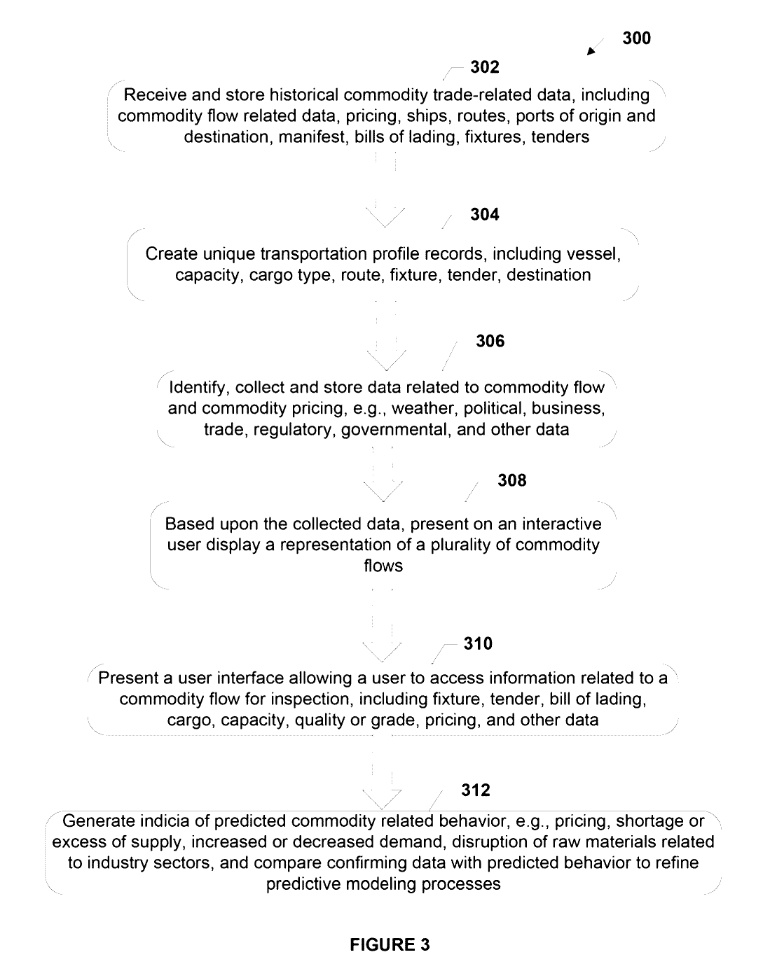

FIGS. 2 and 3 illustrate two exemplary processes of the present invention. As depicted in FIG. 2, at step 202, the system accesses a first set of information relating to a first set of locations (e.g., port, GPS, latitude/longitude) of a set of transportation vehicles (e.g., ships, trains), the first set of locations being of the set of transportation vehicles at a first time. At step 204, the system accesses a second set of information relating to the set of transportation vehicles. The second set of information includes a second set of location data associated with the set of transportation vehicles at a second time. The second time is different than the first time, e.g., later in time to show the progression of a ship along a route from port of origin (e.g., first location) ultimately to port of destination and discharge of cargo (e.g., second location). At step 206, the system accesses a third set of information relating the set of transportation vehicles, the third set of information being related to a set of unique transportation vehicle identifiers. At step 208, the system accesses a fourth set of information relating to the set of transportation vehicles, the fourth set of information including a set of actual transaction data associated with a set of cargo types actually present on and being transported by the set of transportation vehicles during the first journey, the set of actual transaction data comprising data from at least one of the group consisting of: tender data; fixture data; and port inspection data. At step 210, the system forecasts a set of tasks relating to the set of transportation vehicles, the set of tasks and the set of transportation vehicles having a one to one relationship, the set of tasks being based upon the first set of information, the second set of information, and the third set of information, the set of tasks comprising a set of cargo types. At step 212, the system, based upon the set of tasks, generates a set of financial information relating to the set of cargo types (e.g., set of commodities). And at step 214, the system generates an expression representing predicted behavior and/or a suggested action to take in light of the predicted behavior (e.g., buy, sell, hold, risk alert), for example behavior of a traded instrument related to the cargo type (e.g., commodity).

As depicted in FIG. 3, at step 302, the system receives and stores historical commodity trade-related data, including commodity flow related data, pricing, ships, routes, ports of origin and destination, manifest, bills of lading, fixtures, tenders. At step 304, the system creates unique transportation profile records, including vessel, capacity, cargo type, route, fixture, tender, and destination. At step 306, the system identifies, collects and stores data related to commodity flow and commodity pricing, e.g., weather, political, business, trade, regulatory, governmental, and other data. At step 308, the system, based upon the collected data, presents on an interactive user display a representation of a plurality of commodity flows. At step 310, the system presents a user interface allowing a user to access information related to a commodity flow for inspection, including fixture, tender, bill of lading, cargo, capacity, quality or grade, pricing, and other data. And at step 312, the system generates indicia of predicted commodity related behavior, e.g., pricing, shortage or excess of supply, increased or decreased demand, disruption of raw materials related to industry sectors, and compare confirming data with predicted behavior to refine predictive modeling processes.

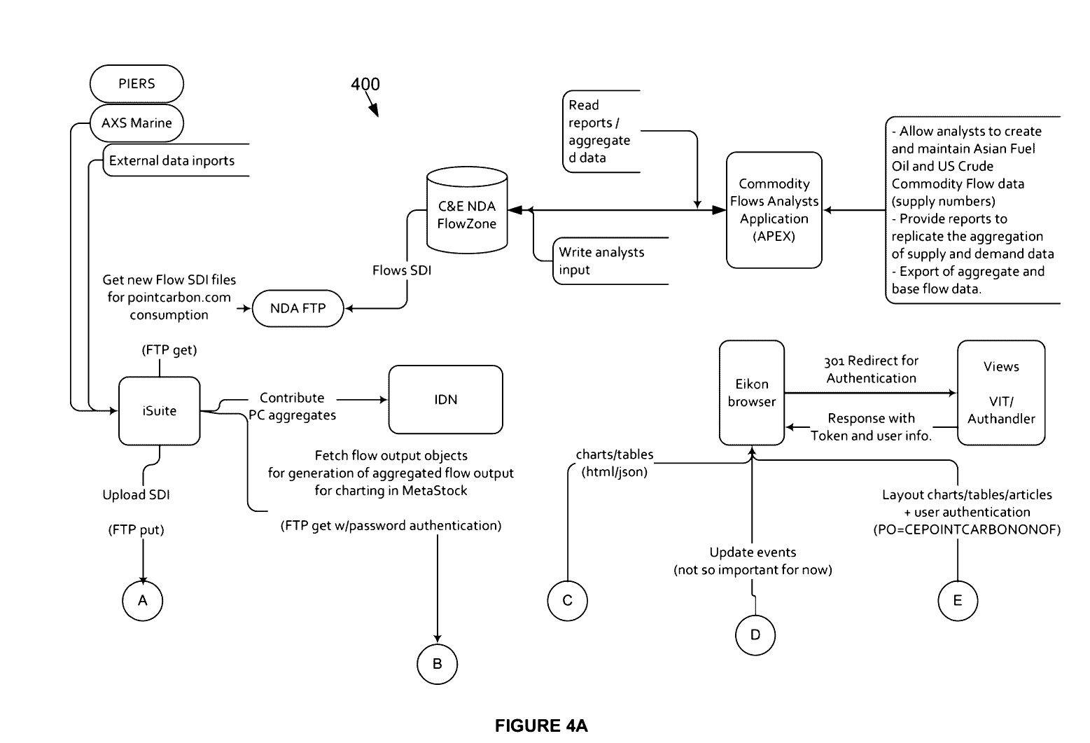

FIGS. 4A/4B represent a single system showing connections A, B, C, D and E and are block, schematic diagrams of one embodiment of the GC SI of the present invention. The system 400 represents commodity flow intelligence application “FlowZone” project architecture. The FlowZone system 400 collects vessel cargo information from internal sources, e.g., Thomson Reuters Business Analysts, Point Carbon and Eikon feeds, etc., and from external third-party data sources, e.g., PIERS, and combines this with existing vessel movement data from AXS Marine, to create a set of Views and charts that will present commodity flow data and show how cargoes are flowing between locations. The system may use a data maintenance screen in NDA, an ingestion mechanism to ingest PIERS U.S. ports data, a data model and database hosted in NDA, a commodity flows SDI to distribute Commodity Flows as entities with associated data. An i Suite data-grab component ports data from the SDI to a FTP site, e.g., system 106 (e.g., Point Carbon). System 400 may use algorithms or models in a Matlab application for aggregation of Flows by region. System 400 may provide “Views,” e.g., Eikon

Point Carbon Views, pages to display data in aggregated and detailed views with links to RICs (Reuters Instrument Codes) and the Interactive Map (iMap).

The Flow Zone information processing system infrastructure provides a global model that, in one application, tracks the physical flow of oil by vessels and pipelines. Data sources presently provide core data and the system 400 may integrate presentation and operation of the commodity flows application onto existing mapping and vessel tracking systems.

As described, the Commodity Flows SDI is used for data exchange between NDA and DWH data warehouse. In addition, the GSCI may publish Commodity Flows SDI to customers as a data feed entity. Preferably the Commodity Flows SDI is compliant with content marketplace standards but may be generated in a tactical “SDI-like” feed. Depending on the universe of users and systems to receive the SDI feed, for versatility the data structure may include certain redundant data such as vessel name, IMO, and RIC. Commodity Flows may include Aggregated flow data generated on the Point Carbon side will in the beginning be supplied to a set of RICs for display in Metastock/Excel/Search via iSuite as a complement to the data in the Views.

The aggregations may be based on a tree structure, e.g., TRCS geography tree structure. This may be done for storage and creation of fuel oil demand numbers. There may also be more forecasting and predictions for future demand and supply. In addition there may be data for more fuels and more geographies. The aggregates may be supplied in a SDI for general distribution and consumption.

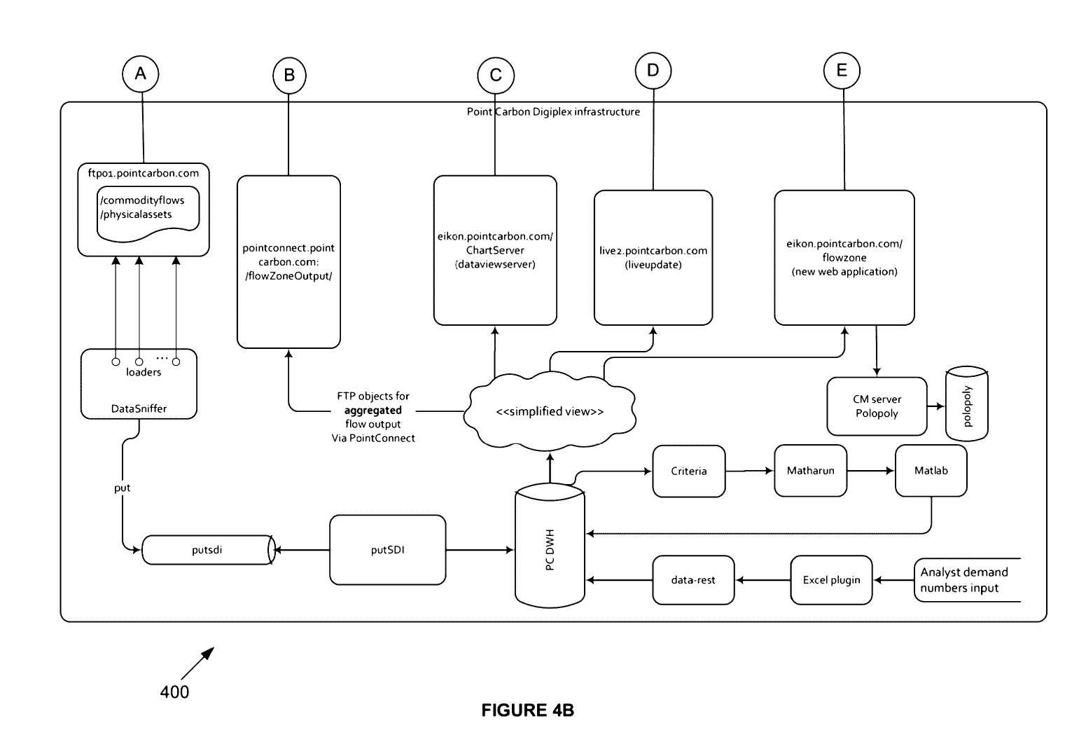

FIGS. 5A/5B represent a single system showing connections A, B, C, D, E and F and are block, schematic diagrams illustrating a further representation of the GCSI of the present invention. The system 500 represents a commodity flow intelligence (CFI) application and architecture. As discussed above and similar to the system 400, the CFI system 500 collects vessel cargo information from internal sources (both data feeds and analyst intelligence) and from external third-party data sources including vessel tracking data, e.g., PIERS, exactEarth (exactEarth Ltd. is a company jointly owned by COM DEV International Ltd and HISDESAT Servicios Estrategicos S.A. and is a data services company that leverages advanced microsatellite technology to deliver monitoring solutions including delivering global AIS vessel tracking data), AXSMarine (AXSMarine produces interactive, Internet-based decision-making tools and databases which support commercial ship chartering activities that are purpose-built for shipbrokers, operators, owners, charterers, research firms and financial institutions). In system 500, iSuite is the core component for delivering data over FTP. FlowZone web application may be delivered over the Internet. iSuite interacts with AXSMarine and PIERS for ftp download, preferably over a secure data access. Standard FTP connections are used throughout the data exchange. iSuite data grabbing/data capabilities—iSuite is core for the data enhancements done for downloading data from the external data providers and distributing internal data.

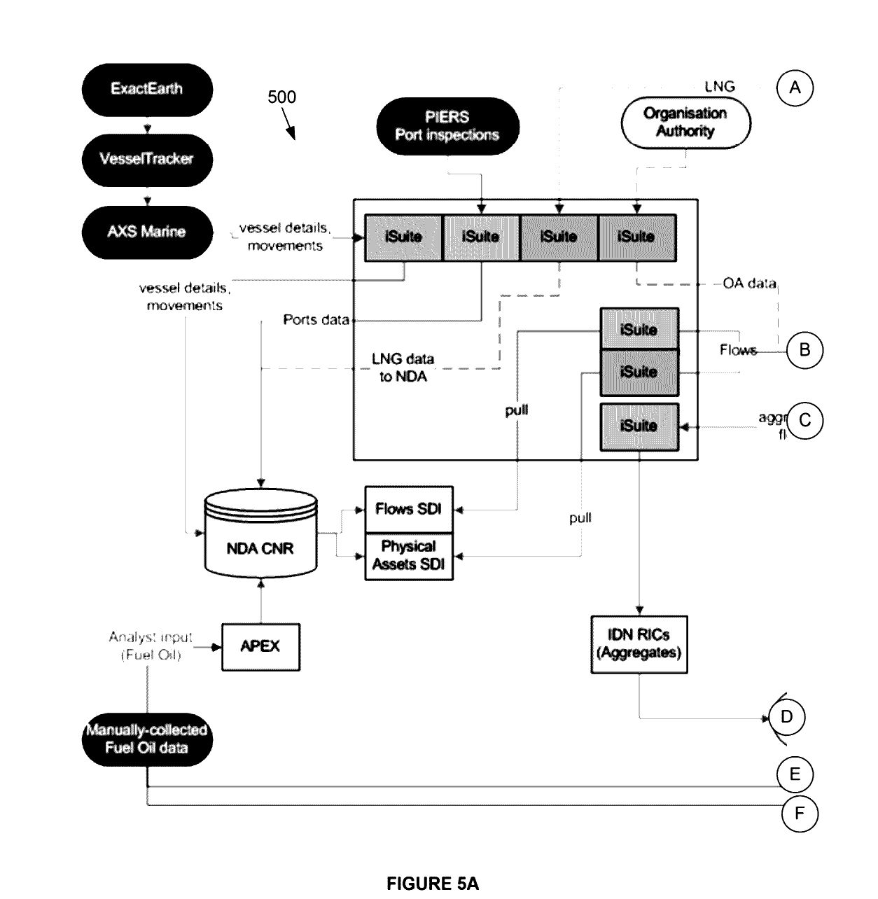

FIG. 6 is a schematic diagram of a client/server/database architecture associated with one implementation of the GSCI of the present invention. With reference to FIG. 6, the present invention provides a Global Supply Chain Information System (“GSCI”) 600 in the form of a global supply chain information news/media and other content database(s) adapted to automatically collect and process internal and external sources of information relevant in analyzing commodity flows. Server 640 is in electrical communication with Global Supply Chain Intelligence (GSCI) databases 610, e.g., over one or more or a combination of Internet, Ethernet, fiber optic or other suitable communication means. Server 640 includes a processor module 641, a memory module 660, which comprises a subscriber (e.g., EIKON, Point Carbon) database 650, a Commodity Flow (or “Flowzone”) module 661, Predictive Generator module 662, a user-interface module 663, a training/learning module 664 and a commodity-related profile module 665. Processor module 641 includes one or more local or distributed processors, controllers, or virtual machines. Memory module 660, which takes the exemplary form of one or more electronic, magnetic, or optical data-storage devices, stores non-transitory machine readable and/or executable instruction sets for wholly or partly defining software and related user interfaces for execution of the processor 641 of the various data and modules 650-665.

Quantitative analysis, techniques or mathematics and models associated with modules 661 to 665 in conjunction with computer science are processed by processor 641 of server 640 thereby rendering server 640 into a special purpose computing machine use to transform records and data related to commodity transactions (e.g., tenders and fixtures) into commodity flow representations and to arrive at predictive behavior, and potentially predictive representations, for use by business analysts. This may include generating a predictive movement of commodity availability and pricing and generating a recommended action or alert, e.g., buy, sell or hold, predicted commodity price, predicted price range over time. The GSCI 600 automatically accesses and processes data concerning commodities, vessels, tenders, and fixtures, along with supplemental data such as weather, political and other subjects that may affect commodity flows.

The GSCI 600 of FIG. 6 includes risk scoring and ERP generating module 662 adapted to process news/media information received as input via news/media corpus 610 and to identify risks associated with particular entities and arrive at risk scoring in processing news/media items related to one or more companies. ERP and risk score may be derived from computational linguistics and define or represent credible statements identified from, e.g., an article. The risk, as discussed in more detail below, will be interpreted as either positive, negative or neutral, and assigned respective polarizations, e.g., scores of +1, −1, and 0. The score may be derived from text and/or metadata from news/media and may apply a predefined or learned lexicon-based risk taxonomy or pattern to the processed text/metadata. Another consideration that GSCI may account for, such as by way of algorithm-based modeling, is congestion delays, which potentially influence the price/value of a cargo, e.g., price of crude oil drops before the vessel can offload and settle the trade on the cargo. Ports are considered assets in the global supply chain. The GSCI may include a Port or Berth Profile function to generate and maintain a port profile based on historic verified shipments arriving at Ports and Berths, i.e., a profile of the types of cargo entering and leaving the port is created bases on actual commodity flows. Similarly, transportation vehicles, e.g., vessels, are assets within the global supply chain. The GSCI may include a Vehicle Profile function to generate and maintain a vehicle profile based on historic vehicle data, e.g., vessel voyages and verified cargoes. Assets, for example vehicles, may also become representative of certain types of trading, i.e., may be used as indicators. The GSCI may include a Route Profile function to generate and maintain a route profile based on the profiles generated for ports and/or vehicles, or related data, using a statistical model to determine the likely cargo shipping routes to associate with a given vehicle and/or predicted commodity flow.

The GSCI 600 may include a training or learning module 664 that analyzes past or archived commodity and transportation data, and may include use of a known training set of data, and may update historical information. In this manner the GSCI may be adapted to build and apply a model or simulation to predict commodity-related behavior given certain types of events, e.g., price of semiconductors rises if the supply of needed materials is short or if a delivery of such materials is canceled or delayed.

In one exemplary implementation, the GSCI 600 may be operated by a traditional financial services company, e.g., Thomson Reuters, wherein GSCI database set 610 includes internal databases or sources of content 620, e.g., TR News 621, Point Carbon Feeds 622, EIKON feeds 623, fixtures/tenders database 624, vessel traffic database 625. In addition, GCSI database set 610 may be supplemented with external sources 630, freely available or subscription-based, as additional data points considered by the GSCI and/or predictive model. News database or source 631 may be a source for confirmed facts, e.g., explosion on an oil rig results in shortage of a commodity and result in increase in demand and price for remaining available supplies. Also, government/regulatory filings database or source 632, vessel tracker database 633, AXS Marine database 634 and PIERS database 635, as well as other sources, provide data to the GSCI system for generating and monitoring and updating commodity flows. This data may also change the commodity flow over time. The results may be used to enhance investment and trading strategies and enable users to track and spot new opportunities.

In one embodiment the GSCI 600 may include a training or machine learning module 664 adapted to derive insight from a broad corpus of commodity-related data. The historical database or corpus may be separate from or derived from GSCI database set 610, which may comprise continuous feeds and may be updated, e.g., in near or close to real time, allowing the GSCI to automatically and timely analyze content, update CFRs based on “new” content, and generate commodity trade or predictive signals in close to real-time, i.e., within approximately one second. However, the wider the scope of data used in connection with the GSCI, the longer the response time may be. To shorten the response time, a smaller window/volume of data/content may be considered. The GSCI may include the capability of generating and issuing timely intelligent alerts and may provide a portal allowing users, e.g., subscription-based analysts, to access not only the CFR and related tools and resources but also additional related and unrelated products, e.g., other Thomson Reuters products.

Content may be received as an input to the GSCI 600 in any of a variety of ways and forms and the invention is not dependent on the nature of the input. Depending on the source of the information, the GSCI will apply various techniques to collect information relevant to commodity flows. For instance, if the source is an internal source or otherwise in a format recognized by the GSCI, then it may identify content related to a particular company or sector or index based on identifying field or marker in the document or in metadata associated with the document. If the source is external or otherwise not in a format readily understood by the GSCI, it may employ natural language processing and other linguistics technology to identify companies in the text and to which statements relate.

The GSCI may be implemented in a variety of deployments and architectures. GSCI data can be delivered as a deployed solution at a customer or client site, e.g., within the context of an enterprise structure, via a web-based hosting solution(s) or central server, or through a dedicated service, e.g., index feeds. FIG. 6 shows one embodiment of the GSCI as comprising an online client-server-based system adapted to integrate with either or both of a central service provider system or a client-operated processing system, e.g., one or more access or client devices 670. In this exemplary embodiment, GSCI 600 includes at least one web server that can automatically control one or more aspects of an application on a client access device, which may run an application augmented with an add-on framework that integrates into a graphical user interface or browser control to facilitate interfacing with one or more web-based applications.

Subscriber database 650 includes subscriber-related data for controlling, administering, and managing pay-as-you-go or subscription-based access of databases 610 or the service. In the exemplary embodiment, subscriber database 650 includes one or more user preference (or more generally user) data structures 651, including user identification data 651A, user subscription data 651B, and user preferences 651C and may further include user stored data 651E. In the exemplary embodiment, one or more aspects of the user data structure relate to user customization of various search and interface options. For example, user ID 651A may include user login and screen name information associated with a user having a subscription to the Commodity Flow service distributed via GSCI 600.

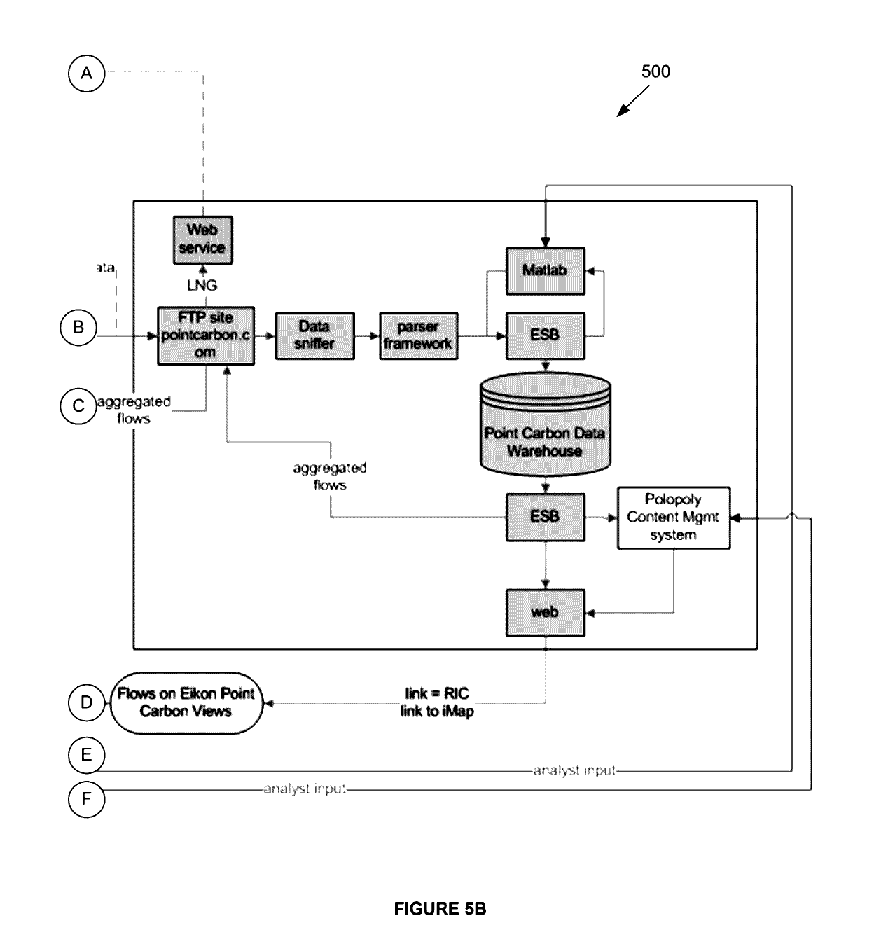

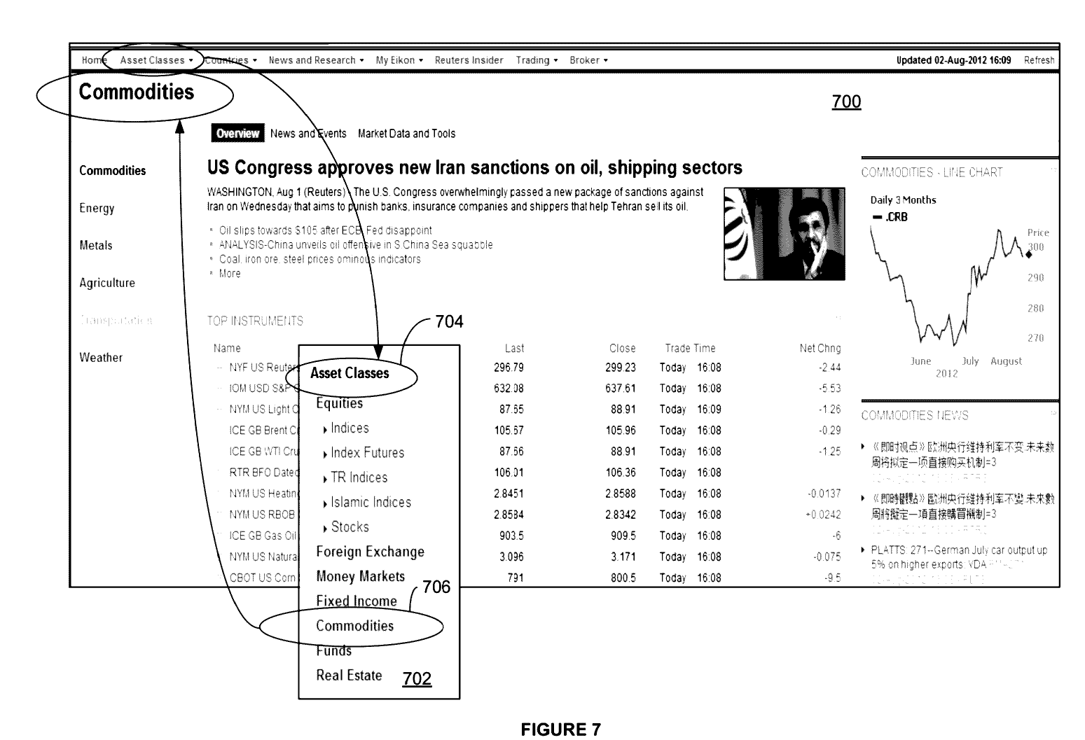

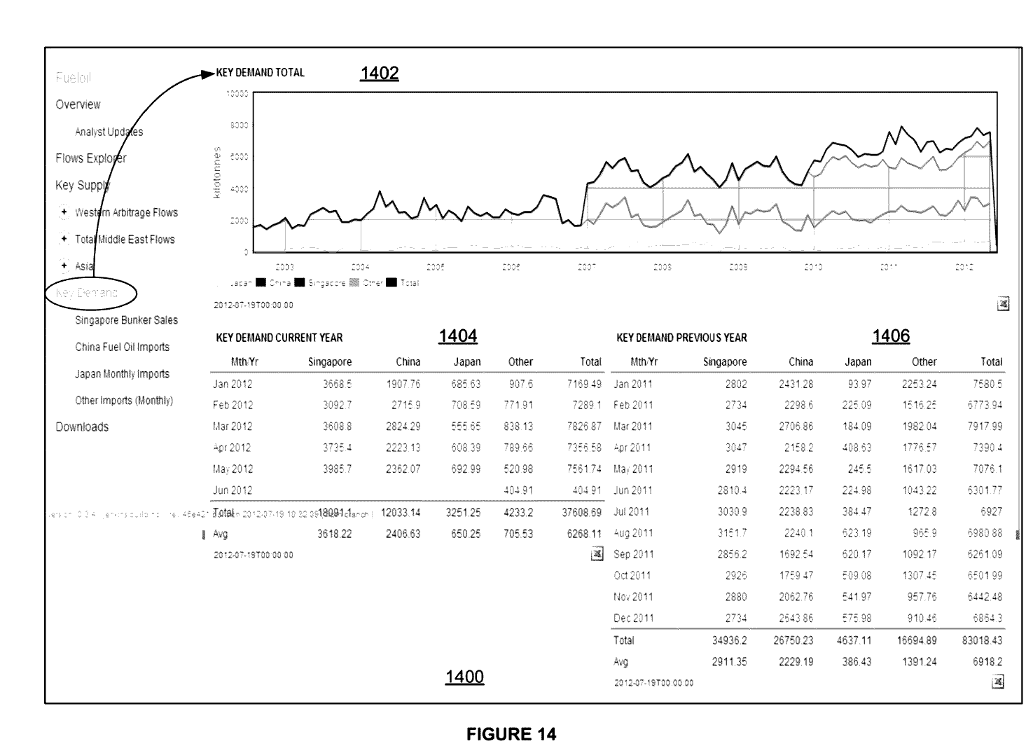

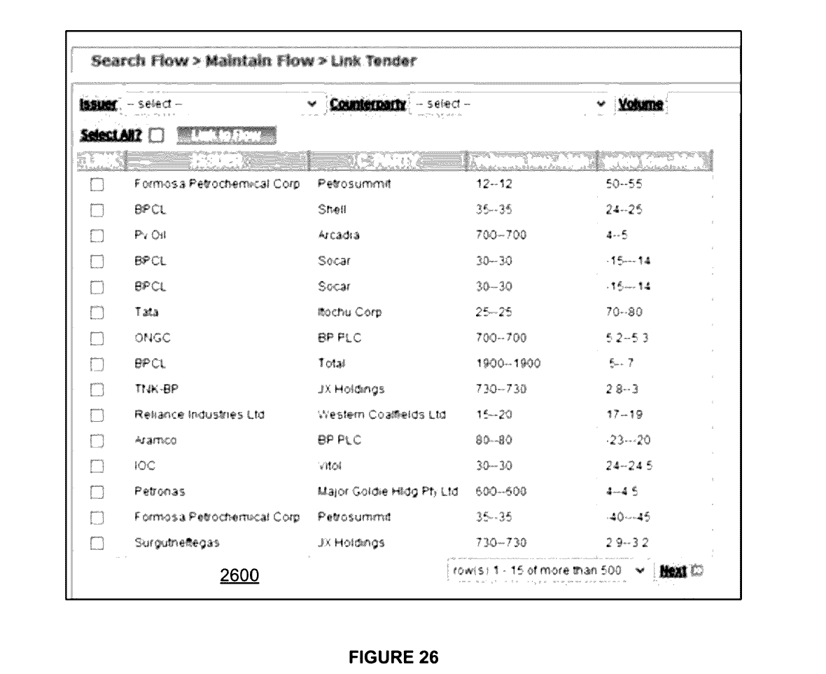

Access device 670, such as a client device, may take the form of a personal computer, workstation, personal digital assistant, mobile telephone, or any other device capable of providing an effective user interface with a server or database. Specifically, access device 670 includes a processor module 671 including one or more processors (or processing circuits), a memory 690, a display 680, a keyboard 672, and a graphical pointer or selector 673. Processor module 671 includes one or more processors, processing circuits, or controllers. Memory 690 stores code (machine-readable or executable instructions) for an operating system 691, a browser 692, document processing software 693, and interactive interface tools (ITT) 694. In the exemplary embodiment, operating system 691 takes the form of a version of the Microsoft Windows operating system, and browser 692 takes the form of a version of Microsoft Internet Explorer. Operating system 691 and browser 692 not only receive inputs from keyboard 672 and selector 673, but also support rendering of graphical user interfaces on display 680. Upon launching processing software an integrated information-retrieval graphical-user interface 681 is defined in memory 690 and rendered on display 680. Upon rendering, interface 681 presents data in association with one or more interactive control features such as iMAP Region 682, toolbar 683, and Commodity Flow Interface 684. Exemplary embodiments of the Commodity Flow Interface 684 are illustrated in FIGS. 7-15, and exemplary embodiments of iMAP Region 682 are illustrated in FIGS. 16-26. An exemplary embodiment of graphical-user interface 681 is represented in FIG. 27.

The included appendix represents exemplary data structures for use with the GSCI system of the present invention. The data structures disclosed are exemplary and illustrative only for purposes of helping to describe an operation of the present invention and are not limiting to the invention.

FIGS. 7-15 illustrate an exemplary set of screens associated with a service for delivering commodity flows, such as via a proprietary system as the Thomson Reuters EIKON and Point Carbon service. In this example, the invention is described in the context of an “Oil Flow” module component of the GSCI and related commodity flows and CFRs maintained therein.

FIGS. 7-10 illustrate exemplary user dashboard or system interface screens associated with navigating a service providing information related to commodities trading with the ability to drill down to focused types of commodities. The screen shots show types of commodity data available for use in connection with the Flowzone Commodities Flow service. With reference to FIG. 7, a commodities related webpage 700 is accessed via a user interface, such as region 702 of an EIKON page (not shown), by accessing “Asset Classes” 704 and clicking on Commodities 706. As shown, user interface screen 700 includes an overview page related to related news links and stories and a listing of “Top Instruments” related to commodities trading. In this example, news related to the Iran sanctions on oil is relevant to the supply and price of crude oil as well as refined products.

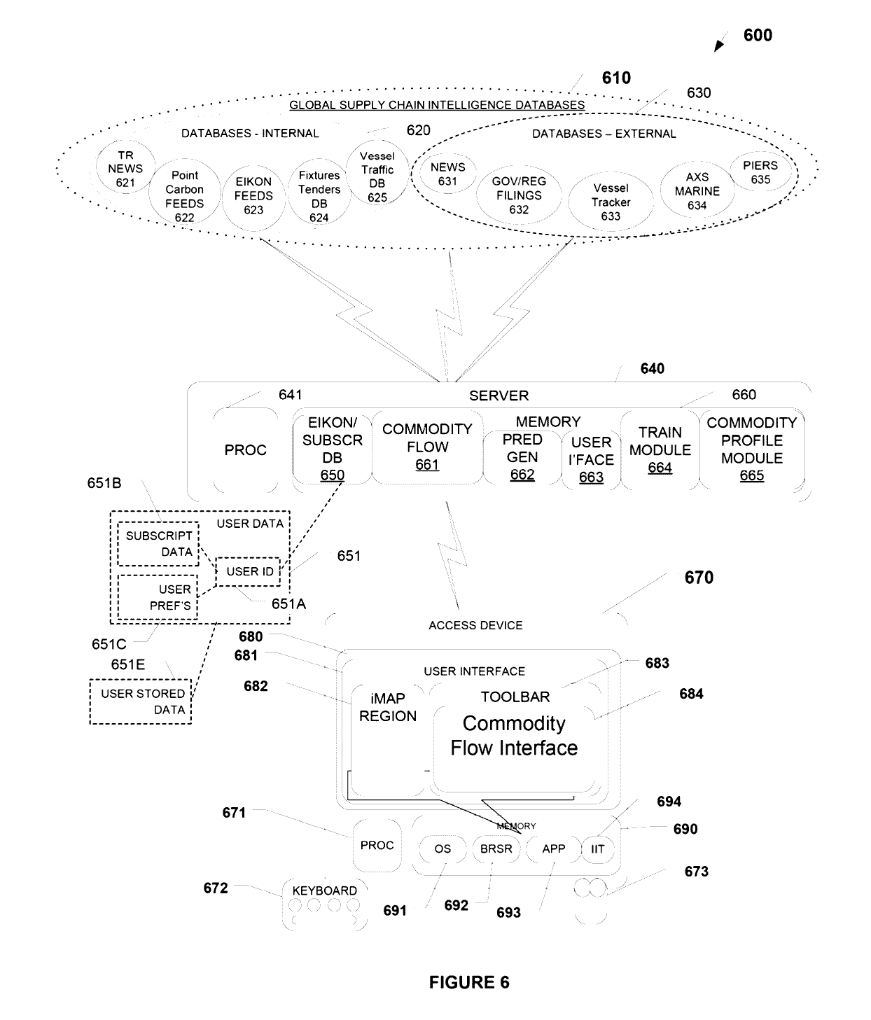

FIG. 8 illustrates an exemplary “Energy” user interface screen 800, which includes am “Energy-Line Chart” related to the pricing of energy instruments over time (between period May-July 2012). Screen 800 also includes a Top Instruments summary region 804 listing top Energy-related instruments traded in the market. Screen 800 also provides links to research and forecasts related to Energy at 806 and Energy-related news at 808.

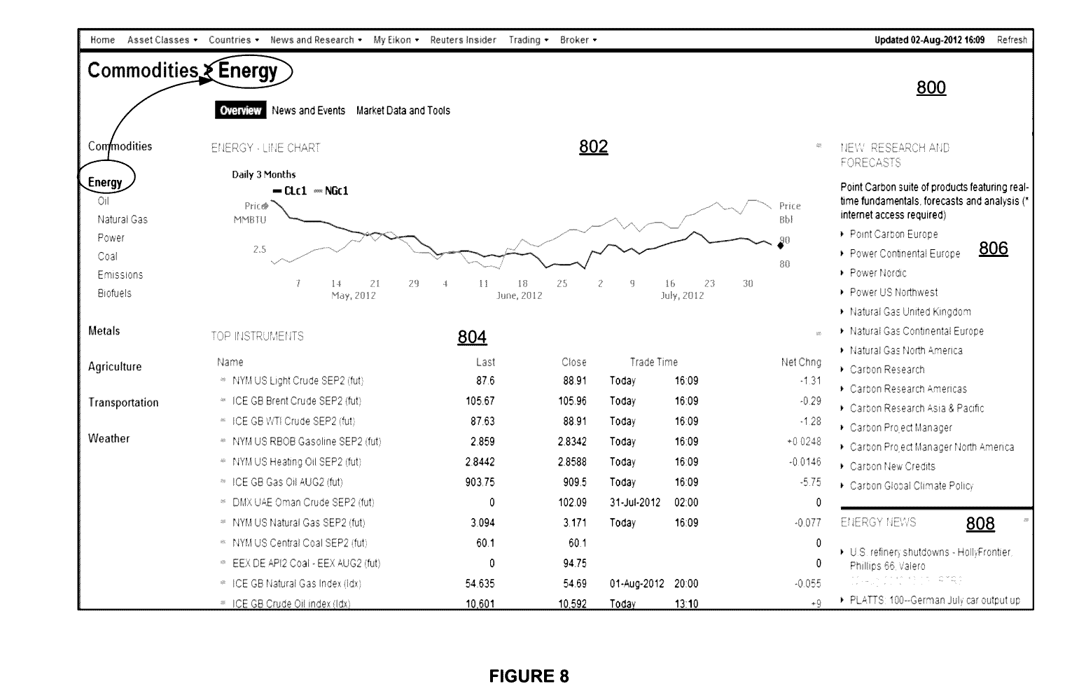

Navigating within Commodities >Energy>Oil presents screen 900 comprising an “Oil-Line Chart” 902 representing pricing of trade instruments related to oil and a “Top Instruments” region 904 related to trading instruments concerning the commodity oil. Upon selecting the “Refined Products” button 906, a user is then presented with a Refined Products screen (not shown) and is allowed to further narrow the focus to “Fuel Oil” as a type of commodity within Refined Products. As shown at FIG. 10, screen 1000 includes a “Fuel Oil-Line Chart” 1002 and a “Top Instruments” region 1004 listing prominent fuel oil instruments traded on the market.

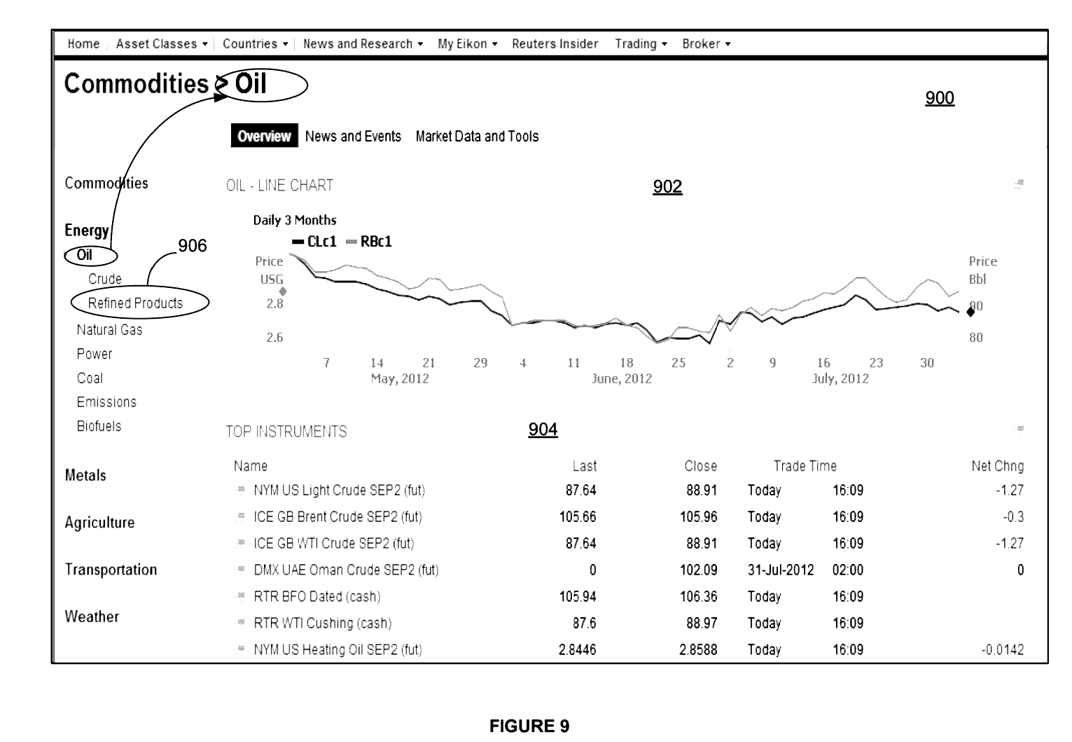

FIGS. 11-15 illustrates functionality associated with the commodities flows application and is shown by way of example in context of integration within an existing Thomson Reuters EIKON service. With reference to FIG. 11, within the commodity area related to Fuel Oil, a Flowzone screen 1100 illustrates graphical representation 1102 of historical data collected and analyzed related to Key Demand as it relates to “China Fuel Oil Imports.” Included in screen 1100 are graphical representations related to “Singapore Bunkers” 1104 and “Aggregated To East” 1106.

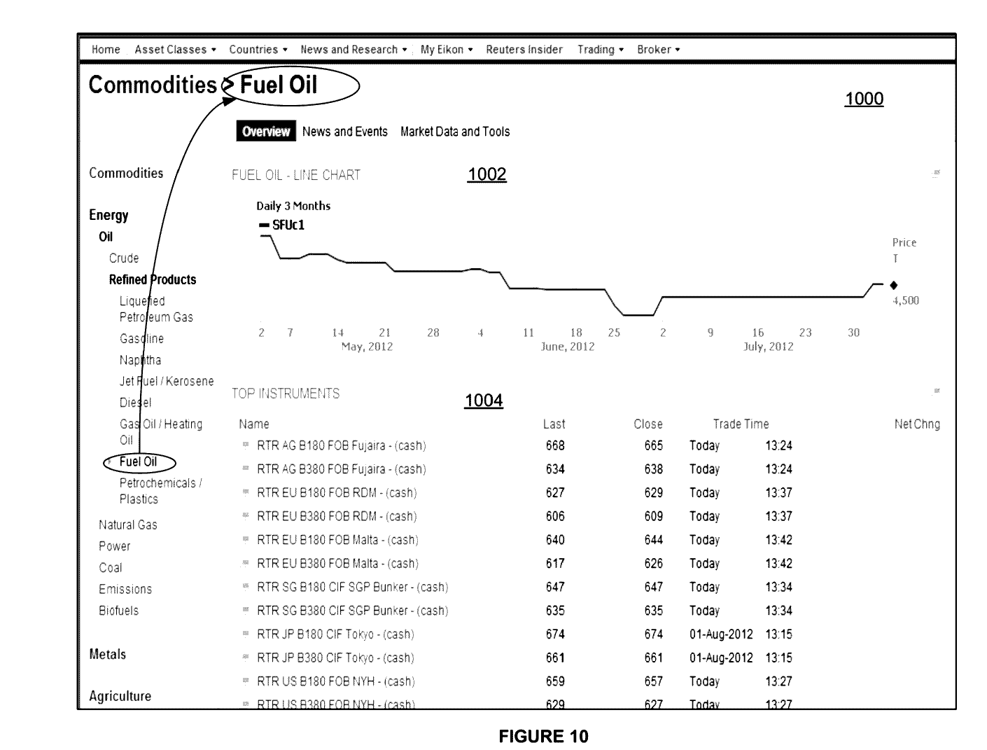

FIG. 12 depicts Flows Explorer screen 1200 within the “Fuel Oil” area of the GSCI 1000. Using the fields provided in region 1202, a user may input criteria designed to identify potential tenders or fixtures of interest. The interest may be to see what volume and grade of a commodity may available (within a date range or not) at a given “Discharge region” or tendered by a particular “Charterer” or to be received by a given “Awardee.” Region 1204 displays the results of flows that match the criteria entered in region 1202. The user may links provided within the data to navigate out to obtain further information.

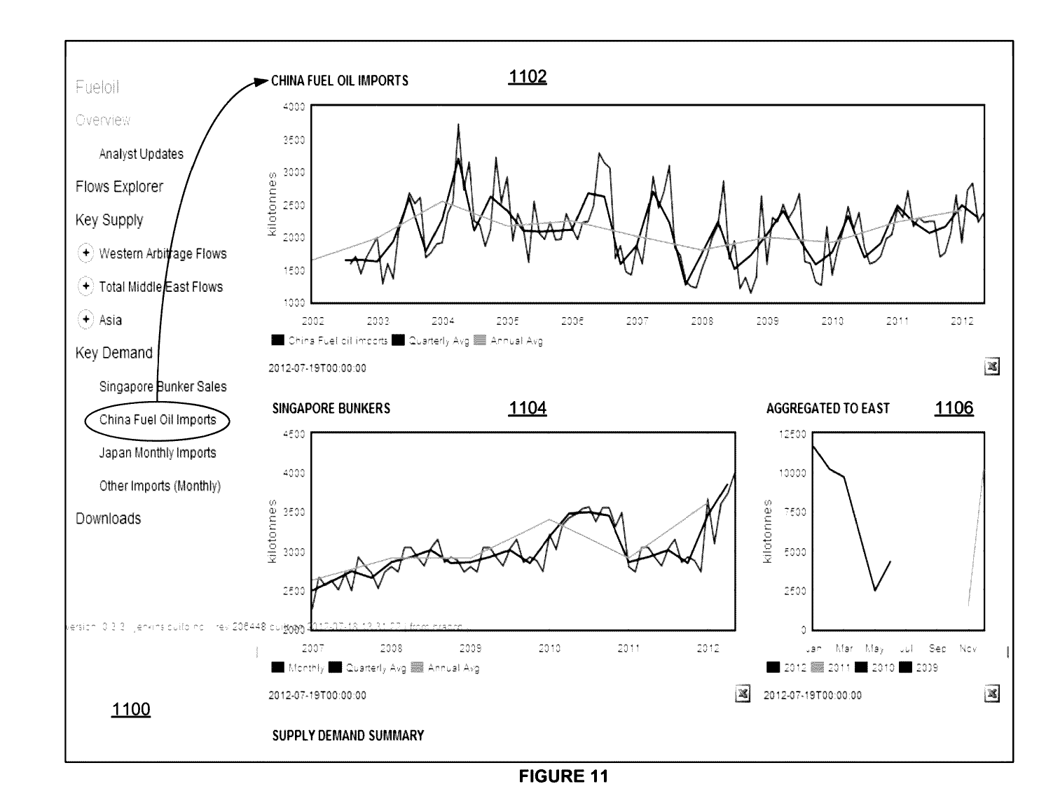

FIG. 13 depicts, within the commodity area related to Fuel Oil, a Flowzone screen 1300 illustrating historical data collected and analyzed related to Key Supply 1302 as it relates to “Total Middle East Flow—Saudi” 1304. Included in screen 1300 is graphical representation 1306 related to “Saudi Arabia To East.”

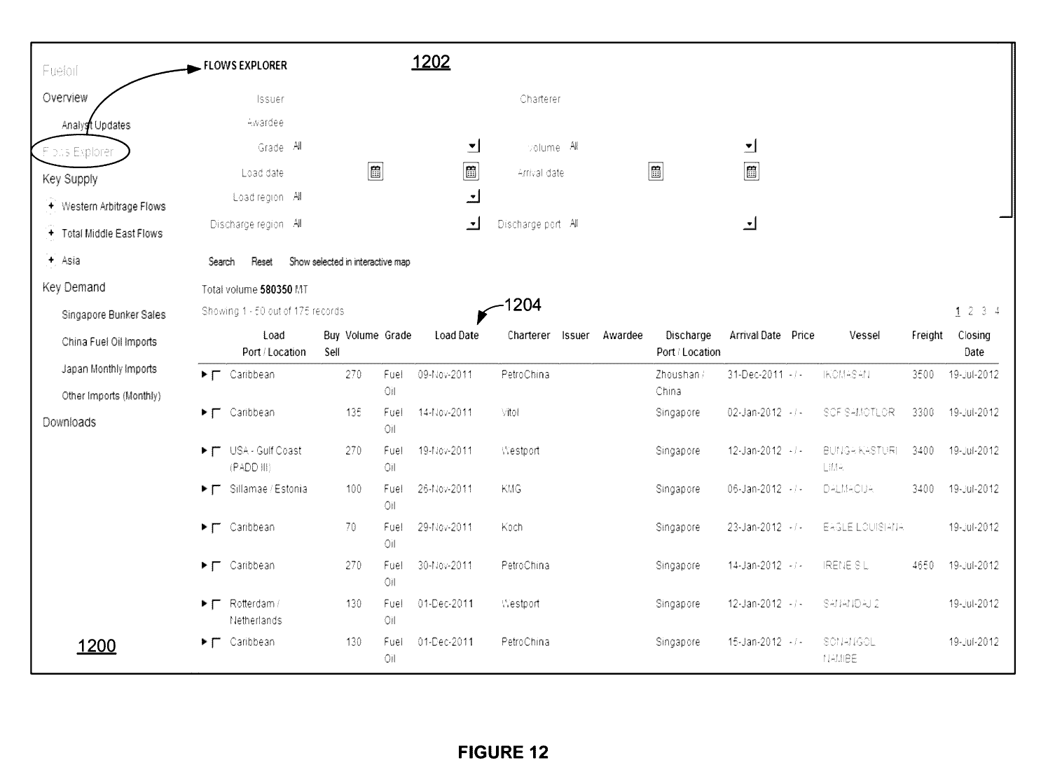

FIG. 14 depicts, within the commodity area related to Fuel Oil, a Flowzone screen 1400 illustrating graphical representation 1402 of historical data collected and analyzed related to Key Demand “Total” which includes data for Singapore Bunker sales, China Fuel Oil imports, Japan monthly imports, and other imports with “Asia.” Included in screen 1400 are tabular representations of historical data related to “Key Demand Current Year” 1404 and “Key Demand Previous Year” 1406.

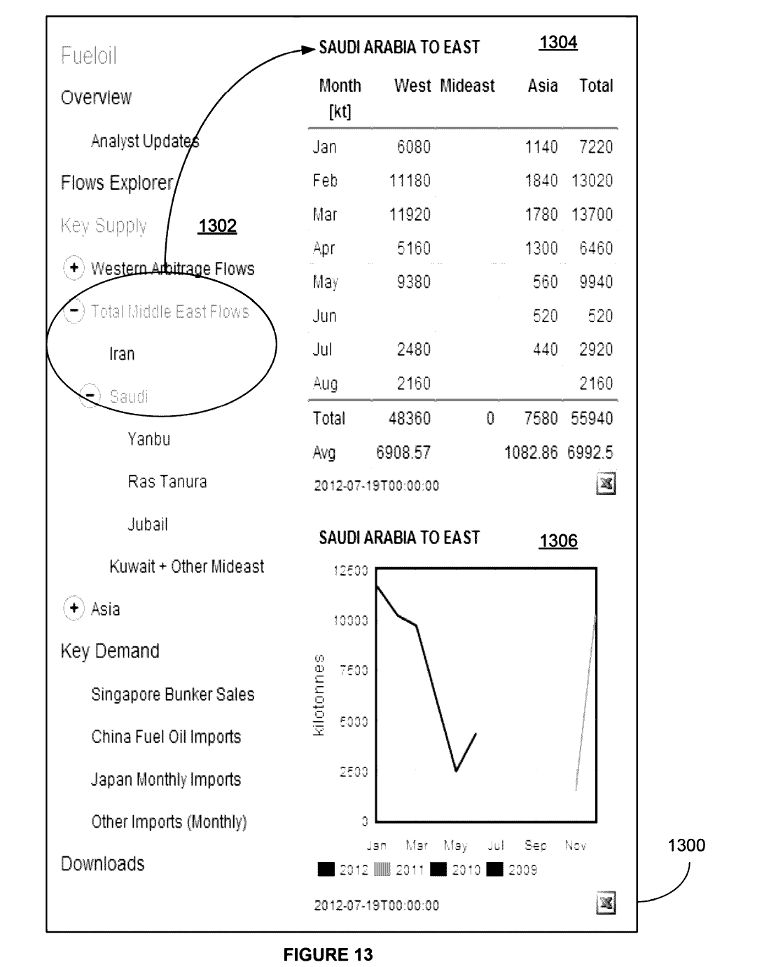

FIG. 15 depicts, within the commodity area related to Fuel Oil, a Flowzone screen 1500 illustrating graphical representation 1502 of historical data collected and analyzed related to “Key Demand >Singapore Bunker Sales” and includes tabular data for “Singapore Bunker Demand” in region 1504.

The historical data collected and maintained by the GSCI may be used to develop a model for predicting price behavior, seasonal changes in supply/demand, anticipated effect of certain types of events (weather, political, etc.) on supply, demand and/or price. Using this model, the GSCI may present to a user an indicator of the analysis and prediction and may provide an alert or a recommended or suggested response to the detected condition. Likewise, alerts or detected conditions may be used as “markers” to gauge the accuracy of the recommendation after following the supply or demand or price of a commodity following an alert or other indication by the GC SI.

FIGS. 16-26 illustrate exemplary user interface and screen shots associated with Editorial Intelligence Commodity Flows creation and management application, e.g., Oracle Application Express (“APEX”), for use in the GSCI of the present invention. Once created, commodity flows and data associated with the commodity flows may be packaged and delivered for use by subscribers of the commodity flow service. In one exemplary manner, a service provider, such as Thomson Reuters, may create and update RICs with aggregate flow volumes.

This data feed will enable users to chart fundamental flow information and build, for example, Excel models. The APEX module is used to create and edit commodity flows and provides intelligent auto suggestions. Analysts can use the application to create a flow even before a vessel is assigned and underway. Auto suggestions will identify possible related ports, tenders, fixtures as well as statistical port and vessel profiles. Once a manually or automatically created flow is confirmed under way it will be kept up to date by the GSCI. Based on automation confidence criteria a flow update may be flagged to analysts for approval or manual override. Flows not identified at the outset are ultimately captured from customs import/export and port inspection data (e.g., PIERS data). If such a flow cannot be matched to a previously tracked vessel, the flow is created and flagged to the analyst for approval. Predicted flows and automated update confidence may be based on machine learning. Forecasting future discrete commodity flows between parties as well as identifying an actual cargo quantity and quality grade provides significant advantage over simply assuming that a particular type and size of vessel is one to one equivalent to say a full load of fuel oil of an unspecified quality grade.

Commercial offerings tend to be either Vessel or Cargo-centric. Vessel-centric offerings focus on the ship and voyage and the cargo centric datasets are typically aggregated statistics and only available weeks or months after the flow occurred. Other solutions concentrate on settlement calculations and Vessel Experience Factors as a measure for operational performance. FIG. 27, described in detail below, is an exemplary user interface in the context of a Fuel Oil commodity flow transaction.

In another manner of operation, the GSCI may support tracking and reporting inter-route trade chain transactions, i.e., transactions concerning cargo that occur while the vessel is underway with cargo. In this method of operation, the GSCI links the transactions chain of a cargo from before a vessel departs to its final destination and shipper/consignee export/import transaction. There can be one or multiple trades between buyers and sellers, for example Nigeria National Petroleum Corp sells a cargo of crude to Vitol, Vitol sells to Sun, Sun sells to Exxon, Exxon is the last buyer who then imports the cargo to the U.S. As well as buyer and seller details, each trade has its own trade type, price, and volume details. Also, the GSCI may generate Activity Alerts as a way to alert users on flow activity events based on the flow forecasting and discovery features of the invention. The GSCI may also provide a method of harmonizing multiple aggregated statistical trade data sets from different sources and applying system intelligence to verify and supplement discrete flows as well as resolving gaps or duplication.

In keeping with one embodiment of the present invention, editorial information and intelligence is obtained, collected and applied to create, maintain and monitor commodity flows. As discussed above, some data or content is gathered (automatically) from internal operations, databases or sources while other data may be gathered (automatically or semi-automatically) from third party data or sources, e.g., PIERS AXS Marine. However, significant relevant data may not be readily available from any source or at least not consistently. In one manner, the system may rely on “editorial” data and/or intelligence that eventually becomes part of a Flow Record. This editorial data or intelligence may come from the following sources: 1) shipping reports which shipbrokers send out to their clients several times a day; 2) tenders issued by market players looking to sell and buy cargoes; and 3) intelligence or data gathered from the industry in typical communications between market participants. All three means require a business or investment analyst or concern to have sufficient contacts with the market as most, if not all, of the data do not exist in the public realm is carrying. In this manner, an analyst or team can supplement available data sources with other source data to further refine or to verify or confirm accuracy of a Commodity Flow Record. For example, the analyst may then make a decision as to if the particular tanker is carrying the product that he is looking at and tracks the vessel using the Interactive Map (iMAP) tool, monitoring it until it reaches the stated destination.

A further aspect is determining, for example, which tender belongs to what fixture, which in turn becomes a commodity flow in progress. Tender “issues” may be collected and tracked because issuers release details relating to specific cargo, including the loading dates, the issuer, the type and grade of oil cargo it is. Tender “results” are more opaque as issuers typically do not disclose information on awardee/price and so the GSCI looks to other sources in the market. At the time the tender is issued, and once confirmed, the tender becomes a Commodity Flow Record (“CFR”). It becomes a fixture once a vessel is chartered for it. The process of identifying that is to match the laycan, loadport and awardee details from the Tender to the same laycan, loadport and charterer in the shipping reports.

The GSCI may match up a partial automatically generated flow record with other content and may verify flows before publishing or releasing CFRs for use via the GSCI service, e.g., Thomson Reuters EIKON Commodity Flows service. Data and intelligence from market sources may be obtained and used to fill information gaps, however CFRs may not always include all fields or information, e.g., strike price, identity of the awardee may be missing. Missing fields or information may be listed as “unknown.” Preferably, the CFR will at least include the origination and destination of the listed cargo. Using origination and destination data is critical information that may be used to aggregate the commodity flows and to draw higher level supply chain conclusions or predictions. Knowing the total aggregate supply/demand balance of a commodity in a certain time period may be used as a key input to predictive pricing (on any of a local or global level). Again, details may be derived automatically from known data or from extracted data or from market contacts, i.e., anyone along the supply chain ranging from traders, brokers, shippers, surveyors, port agents. Preferably, CFRs are published after information is verified as accurate. However, the vessel can still fail. The CFR is confirmed only when the vessel tracker shows that it is headed for the stated destination.

FIGS. 16-26 illustrate the Editorial Commodity Flows management application, e.g., Oracle Application Express (“APEX”), as a component of the GSCI of the present invention. The APEX is used by analysts to create commodity flows and involves use of database and records and presents links for navigating across records and screens. Note that although the invention is described in terms of commodity flows, and at that in examples dealing with energy >oil>fuel oil, the invention is not limited to such applications and one of ordinary skill in the art would readily recognize the broad application of the invention. FIGS. 16-18 relate to a user selectable tab for “Monitor Commodity Flows.”

In this example, FIG. 16 Represents a user interface screen shot 1600 including a “Create Flow” button 1602 and utility for creating a commodity flow record (CFR) by a user of the GSCI. Region 1604 represents a user interface for performing search function as well as for publishing a created commodity flow. As shown, the user may enter data and search based on fields displayed. For example, and as shown, the fields include: a record identifier (PERM ID); Charterer; vessel; IMO (International Maritime Organization) ship number; cargo or commodity; grade; status; volume or capacity; load date; arrival date; load country; discharge country; discharge port; issuer (tender); awardee (tender); buyer; and seller. Region 1606 is a search flow display area that displays information and data (such as listed above) associated with each commodity flow record (CFR) identified as responsive to a search function performed. In this case, the field “Commodity” was entered as “All” and would return all commodity types responsive to any further narrowing criteria—in this case no further narrowing criteria was entered.

Tracking vessels and collecting data known to be associated with particular vessels is largely accomplished by means of a vessel's IMO number (“IMO” followed by a seven-digit number). The IMO number is a unique permanent number assigned to propelled, sea-going merchant ships of 100 GT and above upon keel laying (with certain exceptions). The IMO number uniquely identifies each ship and is marked in a visible place either on the ship's hull or superstructure, remains unchanged upon transfer of the ship to other flag(s), and is inserted in the ship's certificates. Internal and external sources of data relating to the vessel and its cargo, fixtures, load/discharge port/country, etc., are typically associated with the corresponding vessel's IMO number.

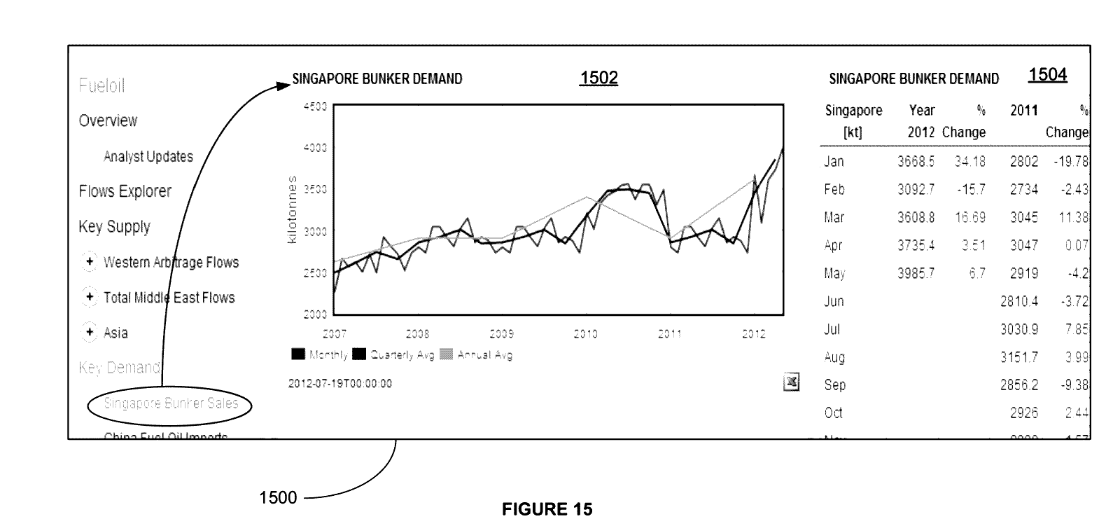

FIG. 17 illustrates an exemplary commodity flow search user interface screen 1700 having a search flow criteria region 1702 for receiving input from a user and a display region 1704 for displaying results responsive to criteria input in region 1702. Region 1706 represents a further function associated with searching using the AXS Marine Fixtures database. In this example, the user has selected “Crude Oil” as a narrowing type of commodity in pull down 1708 and has selected “All” in the “Supply” and “Demand” fields of region 1702. Search Flow region 1704 displays a single response commodity flow record 1710.

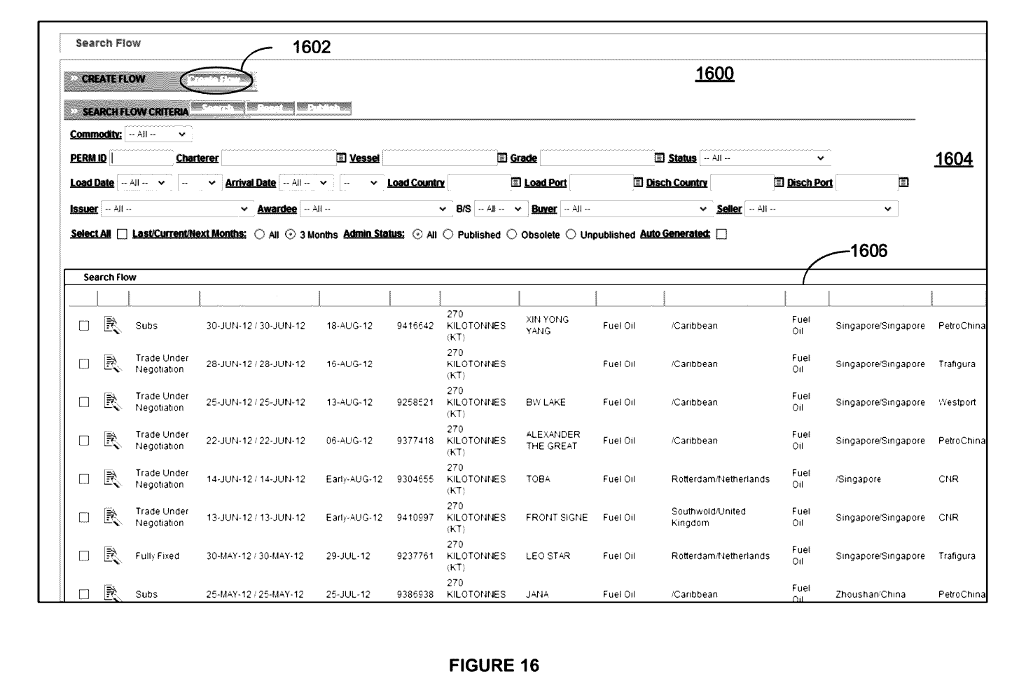

FIG. 18 illustrates a further exemplary user interface screen 1800 for facilitating user searching and monitoring of commodity flows. In this example a user has selected “Crude Oil” at commodity pull down 1801 in search region 1802 along with “All” for both supply and demand. As shown in region 1804, no results were generated based on the criteria selected. The search function may also provide a means for exploring regions and for further narrowing search criteria. For example, a user may be presented with pop-up window 1806 associated with “Carribean/Central America” region, or any other selected region.

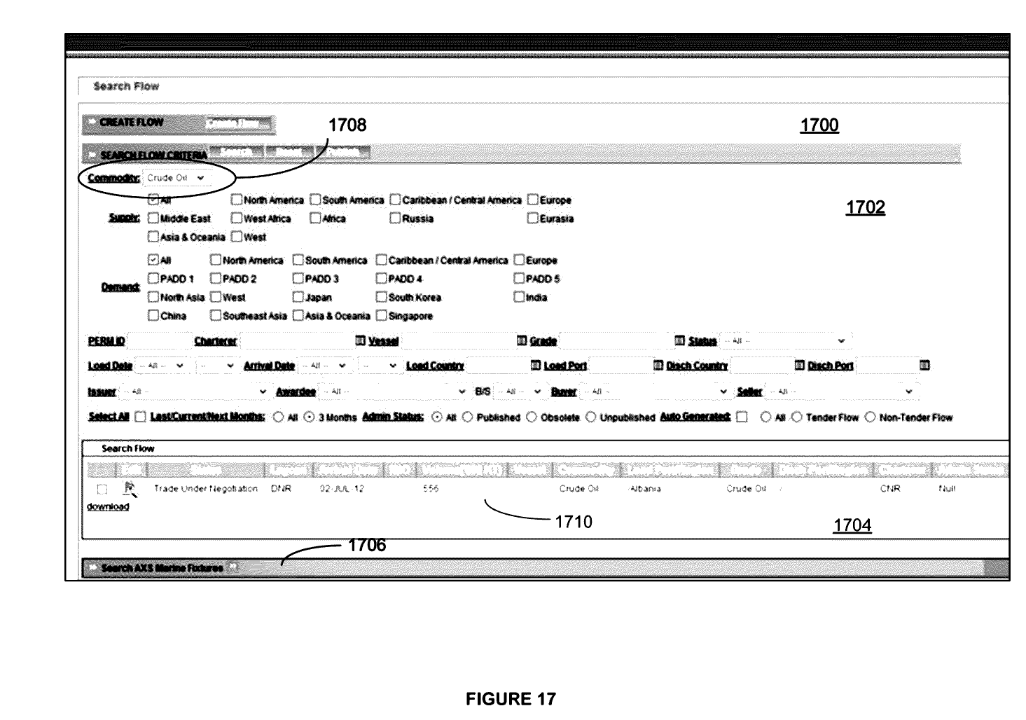

FIGS. 19-22 represents regions of a combined user interface page or dashboard comprised of areas of interest related to monitoring information associated with and concerning a vessel “Maersk Nucleus” and related commodity flows. The overall screen composite may be adjusted to reflect individual user or entity preferences.

FIG. 19 illustrates a search flow user interface screen or region 1900 for “Maintain Flow” and in this example concerning the status of a previously created flow (indicated as “Published”) associated with the vessel “Maersk Nucleus” having assigned IMO number “9322293.” As illustrated, in “shipping” region 1902 this searched and selected CFR indicates the Maersk Nucleus vessel as carrying “Crude Oil” commodity with a volume of 255 KB and a load country of “Algeria.” The status indicates a “Trade Under Negotiation” and no departure date, arrival date or discharge port or region is known. In this interface a user may enter comments related to the vessel, cargo, etc. in comments region 1904. Region 1906 provides an area to enter and display information related to a tender associated with the vessel and its cargo.

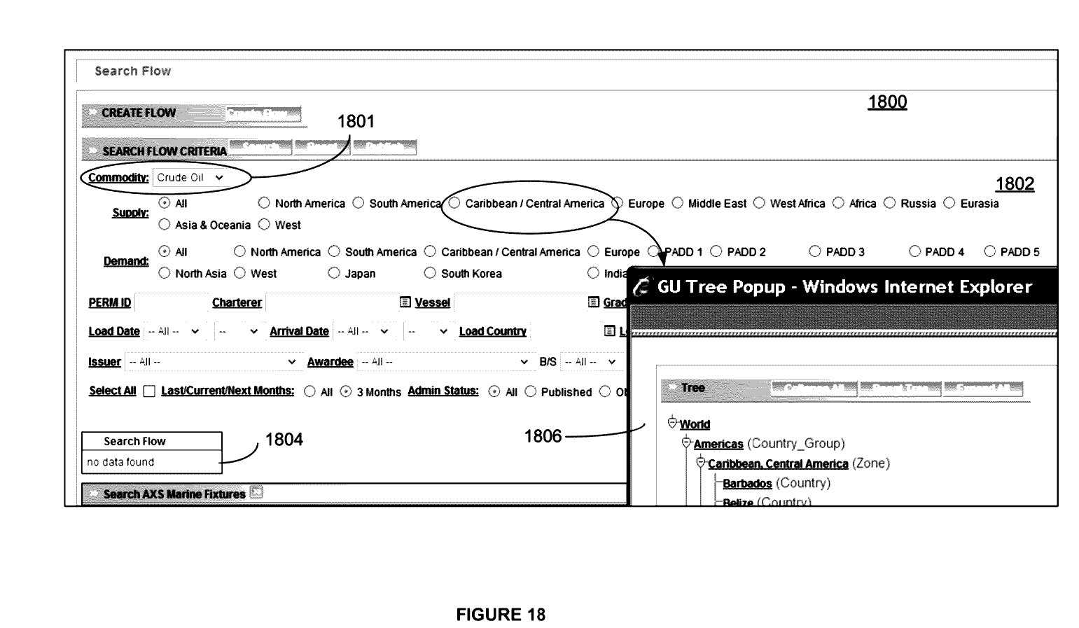

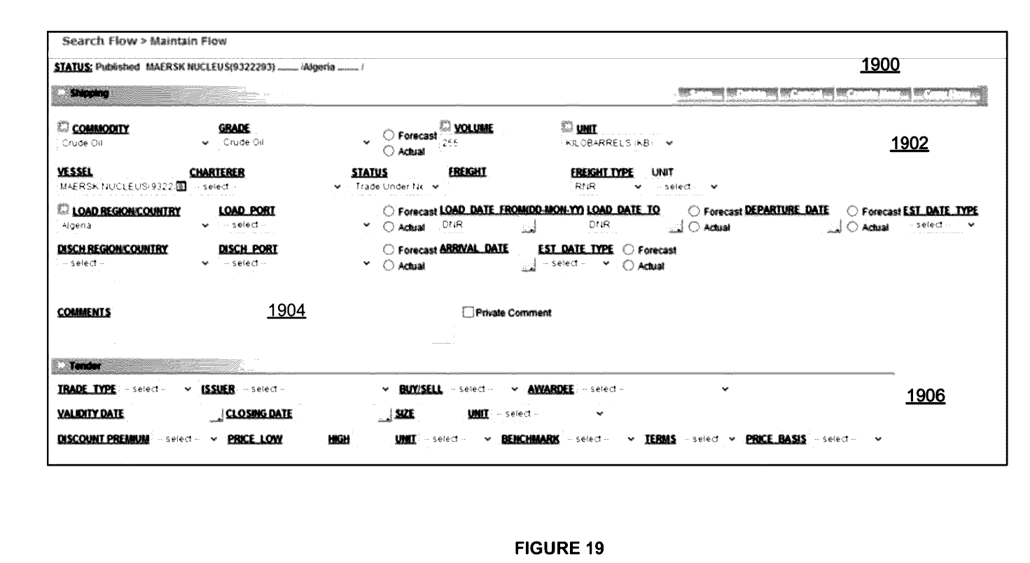

FIG. 20 illustrates a user interface screen or region 2000 for displaying “Movements” tracked and associated by vessel identifier (in this case an identifier assigned other than an IMO number) with “Maersk Nucleus” having assigned “Ves Id” number “69467.” The series of tracking entries showing vessel location or region (“Polygon”) and entry and departure dates or “times,” which match with the graphical representation of the vessel's movements as illustrated in FIG. 21. This screen illustrates the types of data collected and monitored by the GSCI in connection with presenting vessel movement and tracking commodity flows to interested users.

FIG. 21 illustrates an interactive map (iMAP) or region 2100 for graphically or visually displaying movement (historical, present and/or predicted or anticipated) of the vessel “Maersk Nucleus” identified in FIG. 19 and associated with a commodity flow and CFR. In this example numbers and movement lines 2102 represent the sequence and route taken or anticipated to be taken by the vessel being monitored—along with its cargo.

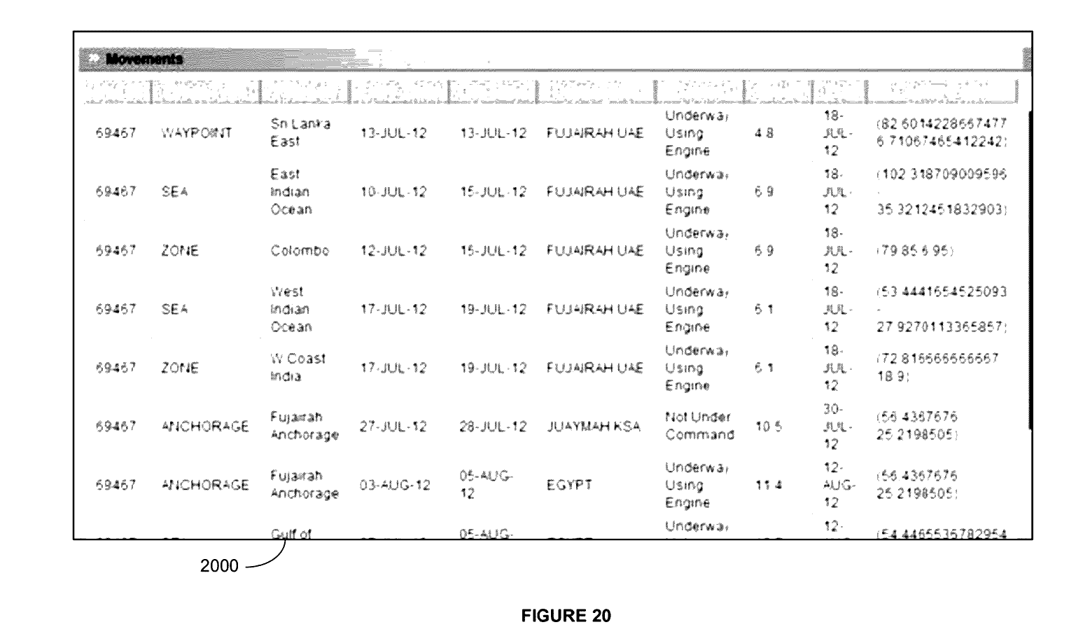

FIG. 22 illustrates an exemplary screen or region 2200 representing records linked to and data associated with the vessel “Maersk Nucleus” identified in FIG. 19 and discussed above. Regions 2202 and 2204 represent, respectively, historical “fixture” and “tender” data associated with the vessel Maersk Nucleus. Region 2206 relates to any port inspection data or records associated with the vessel Maersk Nucleus. Region 2208 represents a commodity flow associated with the vessel Maersk Nucleus.

Attorney Docket No. 113027.000081US2

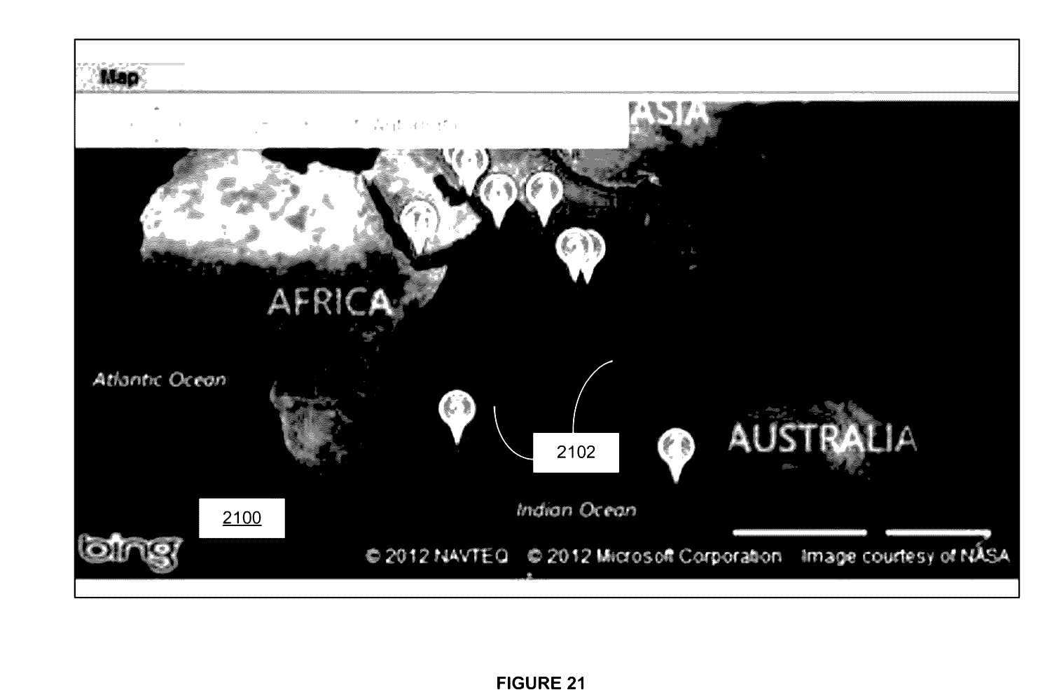

FIG. 23 illustrates an exemplary search screen 2300 for searching PIERS (Port Import Export Reporting Service) database/data. Region 2302 represents a user “Search PIERS Data” function by which users may enter or select search criteria for searching the PIERS database of records, in this case the user has selected to search “IMPORT” in U.S. State “New York” and USPORT “New York for records/cargo matching the description “COM7_DESC—Bread, Cereal, Grain, Malt, Flour.” Region 2304 relates to a display of records resulting from the search criteria entered in region 2302—records associated with vessels, e.g., “Maersk Rimini” that carry cargo matching “COM7_DESC—Bread, Cereal, Grain, Malt, Flour” and scheduled to arrive in New York port.

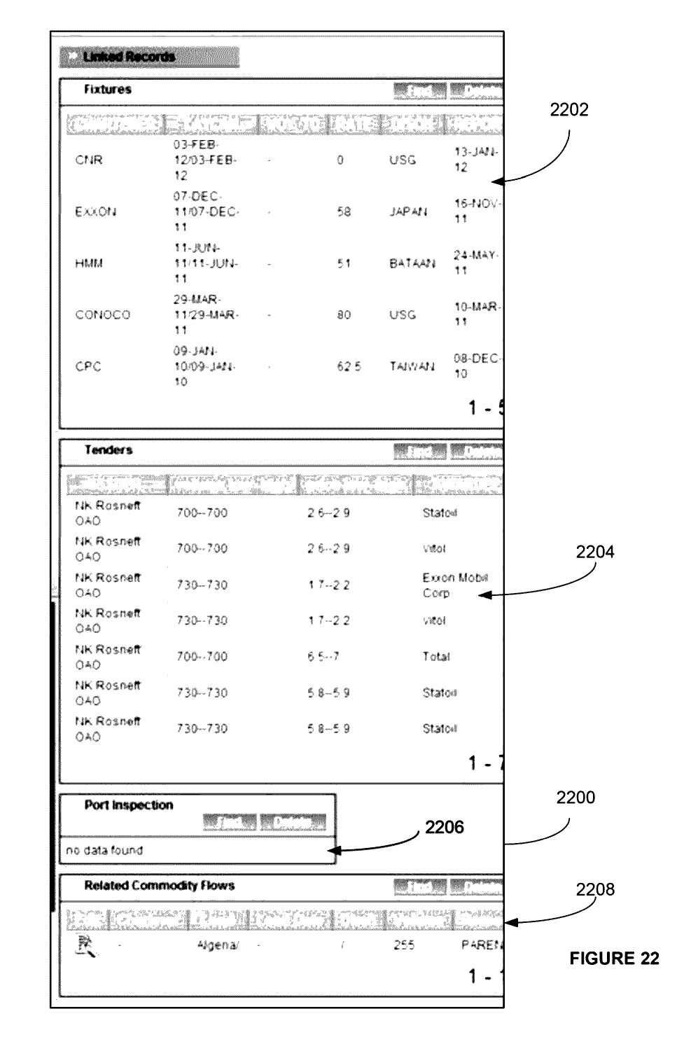

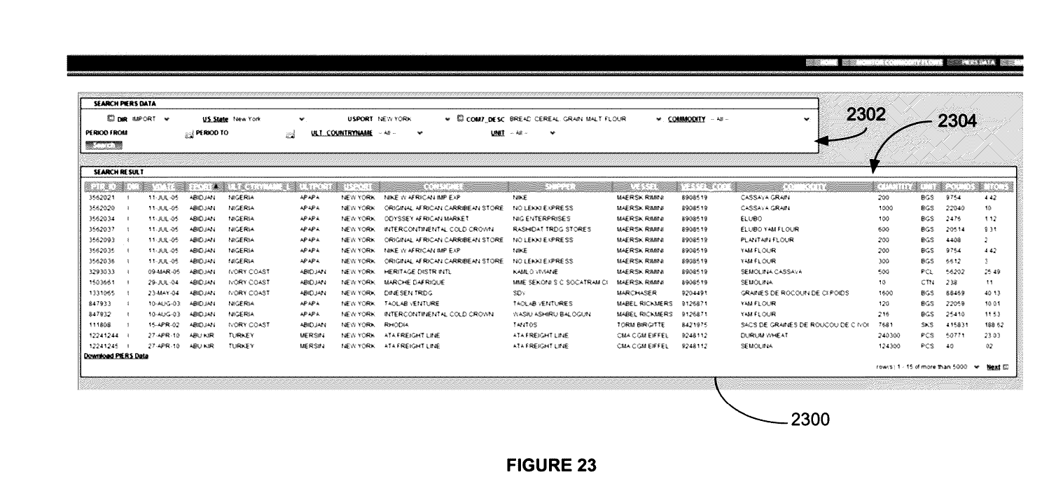

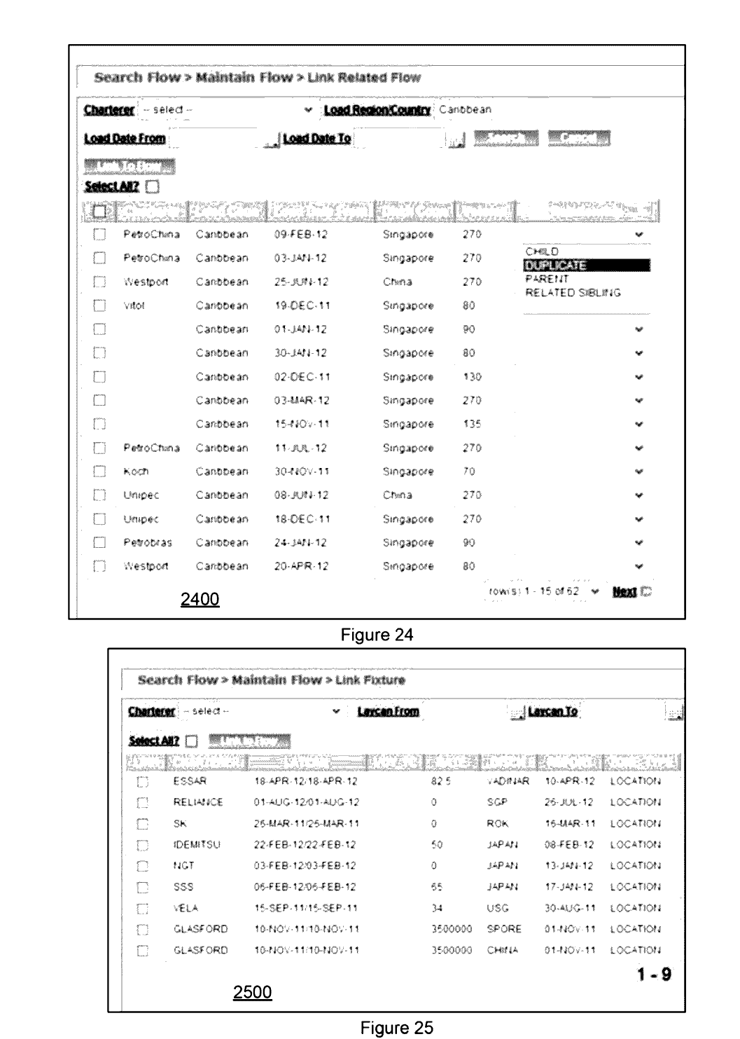

FIG. 24 illustrates a user interface screen 2400 for linking related flows (e.g., child, parent, or sibling) or for identifying flows as duplicates. FIG. 25 illustrates a user interface screen 2500 for selecting fixture records for presenting and for linking fixtures to commodity flows. FIG. 26 illustrates a user interface screen 2600 for selecting tender records for presenting and for linking tenders to commodity flows.

The processes described and depicted herein may be a combination of manual, automated and semi-automated processes.

FIG. 27 is an exemplary graphical representation of the composite dashboard or “Maintain Commodity Flow” screen 2700 related to the vessel “Maersk Nucleus” having IMO #932229 and a particular “Commodity Flow Transaction” involving ExxonMobile as “Charterer” and “Seller” and Vitol as “Buyer.” In this exemplary transaction, as shown in region 2702, the commodity is Fuel Oil and the grade is “380cst.” The status is “verified” and the load port is “Zirku Island” located in load country “Abu Dhabi.” The discharge port is “Kawasaki” in Japan. In addition, load quantity of the commodity and associated pricing information is provided for reference. Region 2704 includes related commodity flows information 2706, fixtures information 2708, tenders information 2710 and port inspection information 2712. Each row is a link to another flow, fixtures, tender, or port inspection data showing additional details. Preferably, this would be to the appropriate view for fixtures, tenders, and possible port inspection data (PIERS initially). Each respective “Find” button may be used to display a pop-up for searching for associated flows, fixtures, tenders, and port inspection data (PIERS). Suggestions may be displayed based on criteria from the CFR transaction region 2702. Region 2714 displays a list of movements labeled 1-7 associated with the vessel and corresponding to identified points labeled 1-7 and routes shown on map region 2716. Estimated dates may be updated and revised manually or automatically such as upon the ship being detected or status showing underway or upon reaching a destination or intermediate port and based on movements and port inspection data. A predictive route pattern may be presented based on known or predicted departure and arrival data and based on historical route data associated with any combination of the vessel, vessel profile, commodity, tender, and/or fixture. Views may be configured based on the selected commodity type in region 2702, e.g., oil vs. agriculture may display different fields relevant to the particular type.

### Supply Chain Visulization Implementation

In one manner the present invention utilizes a set of company names C, a set of commodity types T, and a set of Query Templates Q in performing supply chain analysis and generating supply chain visualizations. The invention utilizes fast access to a variety of data sources to search through a large collection of indexed text documents and other data sources including textual prose documents for which an inverted index has been constructed. In one embodiment of the present invention, a Web search engine (e.g. Bing, Google, DuckDuckGo) serves the function of giving fast access to an indexed document collection.

In one implementation, the process of generating a supply chain graph begins with receiving as input a list of companies, which may be represented as C={“Petrol S.A.”; “BP plc.”; “Cargill”; “Nestle”; “Gazprom”; . . . }. For each of these companies (c¹, c², . . . ) the present invention will determine which other company (supplier) from the list of companies supplies the company (customer) with a given commodity, good, or service, or other thing supplied by a supplier to a customer (interchangeably as a “commodity”) for any given commodity type T={“oil”; “gas”; “beef”; “wheat”; “palm oil”; “crude” . . . }. Determining which companies supply a company with a given commodity type can be done by instantiating a query template q, for example: q=“* supplies {Commodity} to {Company2}”. In the preceding example the serves as a wildcard placeholder for all potential companies that supply the Commodity to Company2. The placeholder is substituted, one company at a time, for all possible placeholders (companies and commodities) in the lists C (list of companies) and T (list of commodities) for all possible q (queries) in Q (the set of queries).

A particular instantiated query template is represented as q′. For example, the instantiated query template q′=“* supplies oil to BP” where “oil” is substituted for Commodity and BP is substituted for Compato;2 (customer) is used to identify which companies from the list of companies C are returned by the particular instantiated query template. In one embodiment the instantiated query template q′ may be sent to a search engine such as, but not limited to, Yahoo! BOSS, in order to obtain the top 1,000 results, i.e. documents, in which q′ ( )OIFS. The symbol “*” functions as a wildcard placeholder variable in q′. This means that there is a token to the left of the word “supplies” which is unknown and is expected to be identified and retrieved by the search performed using the instantiated query q′. A search is them performed for the position in the document indicated by “*” of our query q′ to extract text where the company name from the list of company names C is to the left, i.e., corresponding to the position of the placeholder “*”. Each company found in this position (“*”) for q′ is a candidate result. A company that is identified as a candidate result is a potential supplier of Commodity for Company2 The relationship “supplier” used in this example in both q and q′ may be substituted for any other commercial relationship that may exist between two companies involving a good or service.

The result of performing the search in an identified document using the instantiated query q′ is a set of triples where, in one embodiment, the elements in each triple in the set of triples may be labeled, respectively, as “SupplyingEntity”,“CommodityType”, and “StippliedEntity”. For example, for the specific example of q′ described above, a returned triple in the set of triples may be (“Marathon Oil Corporation”; “oil”; “BP”). The set of triples returned using the instantiated query q′ can be used to construct a supply chain graph by turning each triple into two graph nodes, in this example for SupplyingEntity and SuppliedEntity respectively, which are connected using a vertex labeled with CommodityType. In the present example nodes are created for “Marathon Oil Corporation” (SupplyingEntity) and “BP” (SuppliedEntity) with an arc (directed line) connecting the nodes labeled “oil” (CommodityType).

Additional patterns for a single query template can be found in Table 1:

TABLE 1

| Queries “q” possible in Query Set “Q” | Query Configuration |
|---|---|
| “{Company1} supplies {Commodity} to | no wildcards, 3 variables |
| {Company2}” | |
| “* supplies {Commodity} to {Company2}” | 1 wildcard, 2 variables |
| “{Company1} supplies * to {Company2}” | |
| “{Company1} supplies {Commodity} to *” | |
| “* supplies * to {Company2}” | 2 wildcards, 1 variable |
| “* supplies {Commodity} to *” | |
| “{Company1} supplies * to *” | |
| “* supplies * to *” | 3 wildcards, no variables |

The set Q should use more than one query template to make the technique effective; in addition to “{Company1} supplies {Commodity} to {Company2}”, for example, “{Company1} is a supplier of {Commodity} to {Company2}”, “{Company1} is a vendor of {Commodity} to {Company2}”, “{Company} delivers {Commodity} to {Company2}” etc. are all possible elements of Q. Relationship types or terms used in the query template may include, for example, supplies, delivers, produces, manufactures, mines, extracts, ships, refines, distills, receives, or other terms such that when used in connection with a string such as “{relationship type} {Commodity} {Company1} for {Company2}” or “{Companyl} {relationship type} {Commodity} {Company2}” it indicates a supply relationship between companies. In addition, any preposition such as “to”, “for”, “by”, or “with” may be used in the query to indicate the type of supply relationship involved between the companies. In addition to the query formats described in Table 1, above, the query may also take many different forms, e.g., “{Commodity} supplied by * to {Company2}”, or “{Companyl} receives {Commodity} from *”.

In one implementation of the present invention the frequency of which one triple can be extracted from the top k (e.g., k=1,000) search engine results is counted, summing up the counters over all variant patterns of all templates. The higher the count (which may be normalized by the number of hits of a search for +{Companyl} ±{Company2}), the higher the confidence that the triple extracted is correct.

One method for pattern-based mining to mine risk exposure for companies can be found in the paper by Leidner, J. L. and F. Schilder (2010), entitled “Hunting the Black Swan: Risk Mining From Text,” Demo Paper, Proceedings of the Annual Meeting of the Association for Computational Linguistics (ACL), Sweden, the contents of which is incorporated herein by reference in its entirety.

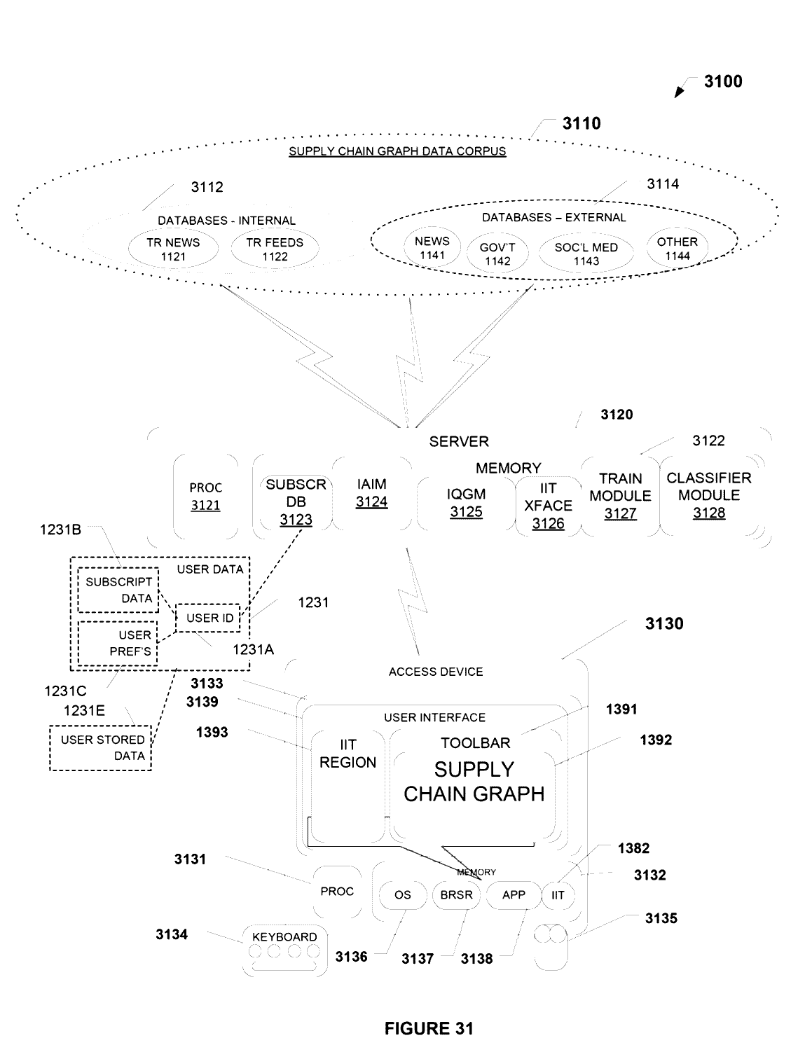

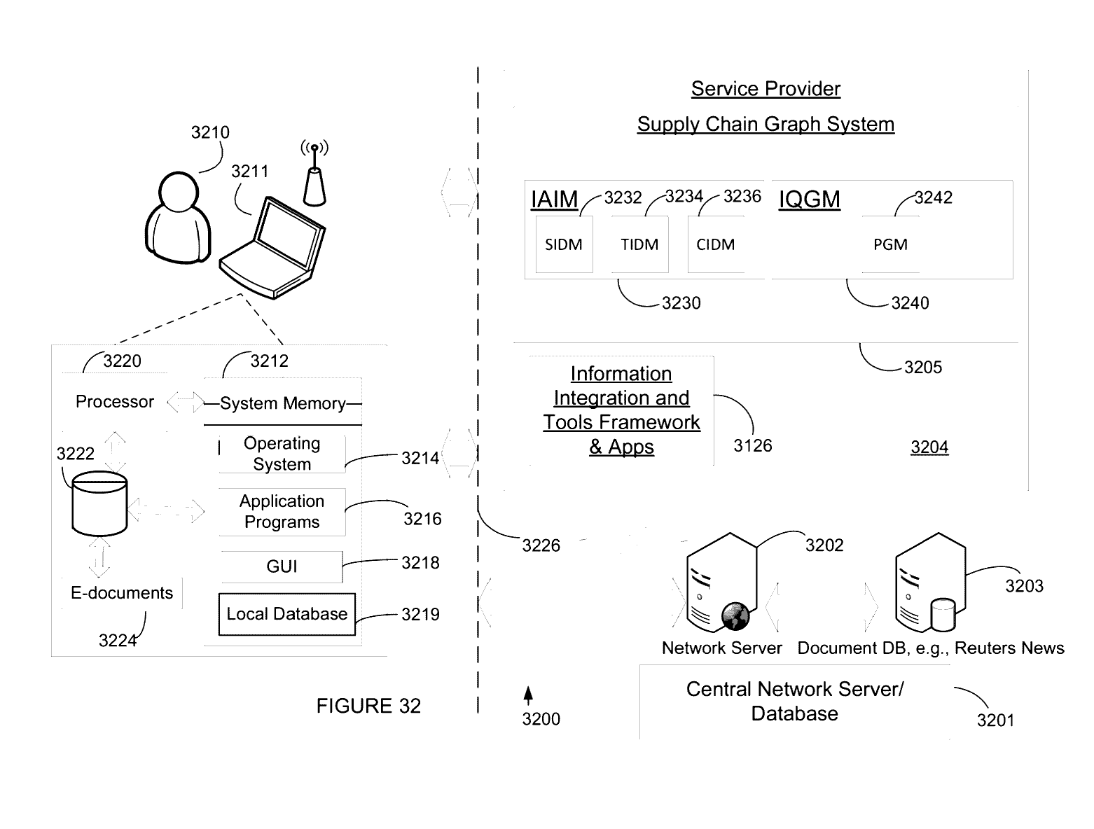

FIGS. 31 and 32 illustrate exemplary embodiments of the overall process of the present invention. FIG. 31 is a schematic diagram of a client/server/database architecture associated with one implementation of the SCGS of the present invention. With reference to FIG. 31, the present invention provides a Supply Chain Graph System (“SCGS”) 3100 that accesses information, collectively referred to at 3110 as global supply chain information, news/media and other content database(s). SCGS 3100 is adapted to automatically collect and process internal and external sources of information (3112, 3114) relevant in collecting supply chain graph information to be used to generate supply chain graphs. Server 3120 is in electrical communication with Supply Chain Graph System (SCGS) databases 3110, e.g., over one or more or a combination of Internet, Ethernet, fiber optic or other suitable communication means. Server 3120 includes a processor 3121 and a memory 3122, in which is stored executable code and data, including a subscriber (e.g., EIKON) database 3123, an Input and Identification Module (“IAIM”) 3124, Instantiated Query Generation Module (“IQGM”) 3125, a user-interface module 3126, a training/learning module 3127 and a classifier module 3128. Processor 3121 includes one or more local or distributed processors, controllers, or virtual machines. Memory 3122, which takes the exemplary form of one or more electronic, magnetic, or optical data-storage devices, stores non-transitory machine readable and/or executable instruction sets for wholly or partly defining software and related user interfaces for execution of the processor 3121 of the various data and modules 3123-3128.

Quantitative analysis, techniques or mathematics and models associated with modules 3124 to 3128 in conjunction with computer science are processed by processor 3121 of server 3120 thereby rendering server 3120 into a special purpose computing machine use to transform records and data related to commodity transactions found in documents and other information in SCGS databases 3110 into supply chain graph representations and to arrive at predictive behavior, and potentially predictive representations, for use by business analysts. This may include generating a set of queries used to identify a set of triples used in generating supply chain graphs. The SCGS 3100 automatically accesses and processes data concerning commodities, vessels, tenders, and fixtures, along with supplemental data such as weather, political and other subjects that may affect commodity availability and pricing.

The SCGS 3100 of FIG. 1 includes an Input and Identification Module (“IAIM”) 3124 adapted to permit the receipt of a set of information including supplier, commodity and customer data sets. The IAIM 3124 further comprises a supplier identification module, a commodity identification module, and a customer identification module for identifying supplier, commodity, and customer related data, respectively, contained in the set of information. The SCGS 3100 also includes an Instantiated Query Generation Module (“IQGM”) 3125 communicatively coupled to the IAIM 3124 for generating a query comprising a supplier entry, a commodity entry, and a customer entry. The IQGM 3125 further comprises a placeholder generation module for inserting a placeholder into the query to represent one or more elements of the query—q. For example, a placeholder may be inserted into the query to represent the supplier entry if the supplier identification module determines a supplier absence in the set of information. In addition, the commodity entry may be represented in the query by a placeholder if the commodity identification module determines a commodity absence in the set of information. Likewise the customer entry may be represented in the query by a placeholder if the customer identification module determines a customer absence in the set of information.

The SCGS 3100 may include a training or learning module 3127 that analyzes past or archived commodity and supply chain data, and may include use of a known training set of data, and may update historical information. In this manner the SCGS may be adapted to build and generate a supply chain graph based on recent events in the marketplace, e.g., price of semiconductors rises if the supply of materials necessary in the manufacture of semiconductors is short or if delivery of such materials is canceled or delayed.

In one exemplary implementation, the SCGS 3100 may be operated by a traditional financial services company, e.g., Thomson Reuters, wherein SCGS database corpus or set 3110 includes internal databases or sources of content 3112, e.g., TR News 1121, and TR Feeds 1122. In addition, SCGS database set 3110 may be supplemented with external sources 3114, freely available or subscription-based, as additional data considered by the SCGS and/or predictive model. News database or source 1141 may be a source for confirmed facts, e.g., explosion on an oil rig results in shortage of a commodity and result in increase in demand and price for remaining available supplies. Also, government/regulatory filings database or source 1142, social media and blogs 1143, as well as other sources 1144, provide data to the SCGS system for generating and monitoring and updating information related to availability and pricing of a commodity. This data changes over time and the SCGS may be used to enhance investment and trading strategies and enable users to track and spot new opportunities in a changing market.

In one embodiment the SCGS 3100 may include a training or machine learning module 3128 adapted to derive insight from a broad corpus of commodity-related data. The historical database or corpus may be separate from or derived from SCGS database set 3110, which may comprise continuous feeds and may be updated, e.g., in near or close to real time, allowing the SCGS to automatically and timely analyze content, update supply chain visualizations based on “new” content, and generate commodity trade or predictive signals in close to real-time, i.e., within approximately one second. However, the wider the scope of data used in connection with the SCGS, the longer the response time may be. To shorten the response time, a smaller window/volume of data/content may be considered. The SCGS may include the capability of generating and issuing timely intelligent alerts and may provide a portal allowing users, e.g., subscription-based analysts, to access not only the supply chain visualizations and related tools and resources but also additional related and unrelated products, e.g., other Thomson Reuters products.

Content may be received as an input to the SCGS 3100 in any of a variety of ways and forms and the invention is not dependent on the nature of the input. Depending on the source of the information, the SCGS will apply various techniques to collect information relevant to commodities and supply chains. For instance, if the source is an internal source or otherwise in a format recognized by the SCGS, then it may identify content related to a particular company or sector or index based on identifying a field or marker in the document or in metadata associated with the document. If the source is external or otherwise not in a format readily understood by the SCGS, it may employ natural language processing (NLP) and other linguistics technology to identify commodities and companies in the text as well as terms that indicate the existence of a supply chain relationship.

The SCGS 3100 may be implemented in a variety of deployments and architectures. SCGS data can be delivered as a deployed solution at a customer or client site, e.g., within the context of an enterprise structure, via a web-based hosting solution(s) or central server, or through a dedicated service, e.g., index feeds. FIG. 1 shows one embodiment of the SCGS as comprising an online client-server-based system adapted to integrate with either or both of a central service provider system or a client-operated processing system, e.g., one or more access or client devices 3130. In this exemplary embodiment, SCGS 3100 includes at least one web server that can automatically control one or more aspects of an application on a client access device, which may run an application augmented with an add-on framework that integrates into a graphical user interface or browser control to facilitate interfacing with one or more web-based applications.

Subscriber database 3123 includes subscriber-related data for controlling, administering, and managing pay-as-you-go or subscription-based access of databases 3110 or the service. In the exemplary embodiment, subscriber database 3123 includes user data (or more generally user) as data structures 1231, including user identification data 1231A, user subscription data 1231B, and user preferences 1231C and may further include user stored data 1231E. In the exemplary embodiment, one or more aspects of the user data structure relate to user customization of various search and interface options. For example, user ID 1231A may include user login and screen name information associated with a user having a subscription to the services accessed and distributed via SCGS 3100.

Access device 3130, such as a client device, may take the form of a personal computer, workstation, personal digital assistant, mobile telephone, or any other device capable of providing an effective user interface with a server or database. Specifically, access device 3130 includes a processor module 3131 including one or more processors (or processing circuits), a memory 3132, a display 3133, a keyboard 3134, and a graphical pointer or selector 3134. Processor module 3131 includes one or more processors, processing circuits, or controllers. Memory 3132 stores code (machine-readable or executable instructions) for an operating system 3136, a browser 3137, supply chain graph software 3138, and interactive interface tools (ITT) 1382. In the exemplary embodiment, operating system 3136 takes the form of a version of the Microsoft Windows operating system, and browser 3137 takes the form of a version of Microsoft Internet Explorer. Operating system 3136 and browser 3137 not only receive inputs from keyboard 3134 and selector 3135, but also support rendering of graphical user interfaces on display 3133. Upon launching processing software an integrated information-retrieval graphical-user interface 3139 is defined in memory 3132 and rendered on display 3133. Upon rendering, interface 3139 presents data in association with one or more interactive control features such as user interface tools region 1393, toolbar 1391, and Supply Chain Graph System interface 1392. The interface 1392 may be incorporated into, comprise, or consist of a variety of existing software solutions or GUIs, such as those found in U.S. patent Application Ser. No. 13/423,127, filed Mar. 16, 2012, and entitled METHODS AND SYSTEMS FOR RISK MINING AND FOR GENERATING ENTITY RISK PROFILES (Leidner et. al.); U.S. patent aplication Ser. No. 13/423,134, filed Mar. 16, 2012, and entitled METHODS AND SYSTEMS FOR GENERATING ENTITY RISK PROFILES AND FOR PREDICTING BEHAVIOR OF SECURITY (Leidner et al.); U.S. patent application Ser. No. 13/594,864, filed Aug. 26, 2012, and entitled METHODS AND SYSTEMS FOR MANAGING SUPPLY CHAIN PROCESSES AND INTELLIGENCE (Siig et. al.); all of which are incorporated by reference herein in their entirety.

In one embodiment of operating a system using the present invention, an add-on framework is installed and one or more tools or APIs on server 3120 are loaded onto one or more client devices 130. In the exemplary embodiment, this entails a user directing a browser in a client access device, such as access device 3130, to Internet-Protocol (IP) address for an online information-retrieval system, such as offerings from Thomson Reuters Financial and other systems, and then logging onto the system using a username and/or password. Successful login results in a web-based interface being output from server 3120, stored in memory 3132, and displayed by client access device 3130. The interface includes an option for initiating download of information integration software with corresponding toolbar plug-ins for one or more applications. If the download option is initiated, download administration software ensures that the client access device is compatible with the information integration software and detects which document-processing applications on the access device are compatible with the information integration software. With user approval, the appropriate software is downloaded and installed on the client device. In one alternative, an intermediary “firm” network server, such as one operated by a financial services customer, may receive one or more of the framework, tools, APIs, and add-on software for loading onto one or more client devices 130 using internal processes.

Once installed in whatever fashion, a user may then be presented an online tools interface in context with a document-processing application. Add-on software for one or more applications may be simultaneous invoked. An add-on menu includes a listing of web services or application and/or locally hosted tools or services. A user selects via the tools interface, such as manually via a pointing device. Once selected the selected tool, or more precisely its associated instructions, is executed. In the exemplary embodiment, this entails communicating with corresponding instructions or web application on server 3120, which in turn may provide dynamic scripting and control of the host word processing application using one or more APIs stored on the host application as part of the add-on framework.

FIG. 32 illustrates another representation of an exemplary SCGS system 3200 for carrying out the herein described processes that are carried out in conjunction with the combination of hardware and software and communications networking. In this example, SCGS 3200 provides a framework for searching, retrieving, analyzing, and ranking. SCGS 3200 may be used in conjunction with a system 3204 offering of an information or professional financial services provider (FSP), e.g., Thomson Reuters Financial, and include an Information Integration and Tools Framework and Applications module 3126, as described hereinabove. Further, in this example, system 3200 includes a Central Network Server/Database Facility 3201 comprising a Network Server 3202, a Database 3203 of documents and information, from internal and/or external sources, e.g., news stories, blogs, social media, etc., an Supply Chain Graph System 3205 having as components an IAIM 3230 comprising supplier identification module (“SIDM”) 3232, commodity identification module (“TIDM”) 3234, and customer identification module (“CIDM”) 3236, and an IQGM 3240 comprising placeholder generation module (“PGM”) 3242.

The Central Facility 3201 may be accessed by remote users 3210, such as via a network 3226, e.g., Internet. Aspects of the system 3200 may be enabled using any combination of Internet or (World Wide) WEB-based, desktop-based, or application WEB-enabled components. The remote user system 3210 in this example includes a GUI interface operated via a computer 3211, such as a PC computer or the like, that may comprise a typical combination of hardware and software including, as shown in respect to computer 3211, system memory 3212, operating system 3214, application programs 3216, graphical user interface (GUI) 3218, processor 3220, and storage 3222, which may contain electronic information 3224 such as electronic documents and information, e.g., commodity and/or industry reports, and company related reports and information.

The methods and systems of the present invention, described in detail hereafter, may be employed in providing remote users, such as investors, access to a searchable database. In particular, remote users may search a database using search queries based on company RIC, a commodity listing, stock or other name to retrieve and view predictive analysis and/or suggested action as discussed hereinbelow. RIC refers to Reuters instrument code, which are ticker-like codes used to identify financial instruments and indices, are used for looking up information on various financial information networks (like Thomson Reuters market data platforms, e.g., Bridge, Triarch, TIB and RMDS—Reuters Market Data System (RMDS) open data integration platform). Client side application software may be stored on machine-readable medium and comprising instructions executed, for example, by the processor 3220 of computer 3211, and presentation of web-based interface screens facilitate the interaction between user system 3210 and central system 3211, such as tools for further analyzing the data streams and other data and reports received via network 3226 and stored locally or accessed remotely. The operating system 214 should be suitable for use with the system 3201 and browser functionality described herein, for example, Microsoft Windows 8, Windows Vista (business, enterprise and ultimate editions), Windows 7, or Windows XP Professional with appropriate service packs. The system may require the remote user or client machines to be compatible with minimum threshold levels of processing capabilities, e.g., Intel i3, i5, i7, speed, e.g., 1-2 GHz, minimal memory levels and other parameters.

The configurations thus described are ones of many and are not limiting as to the invention. Central system 201 may include a network of servers, computers and databases, such as over a LAN, WLAN, Ethernet, token ring, FDDI ring or other communications network infrastructure. Any of several suitable communication links are available, such as one or a combination of wireless, LAN, WLAN, ISDN, X.25, DSL, and ATM type networks, for example. Software to perform functions associated with system 3201 may include self-contained applications within a desktop or server or network environment and may utilize local databases, such as SQL 2005 or above or SQL Express, IBM DB2 or other suitable database, to store documents, collections, and data associated with processing such information. In the exemplary embodiments the various databases may be a relational database. In the case of relational databases, various tables of data are created and data is inserted into, and/or selected from, these tables using SQL, or some other database-query language known in the art. In the case of a database using tables and SQL, a database application such as, for example, MySQLTM, SQLServer™, Oracle 8I™, 10 G™, or some other suitable database application may be used to manage the data. These tables may be organized into an RDS or Object Relational Data Schema (ORDS), as is known in the art.

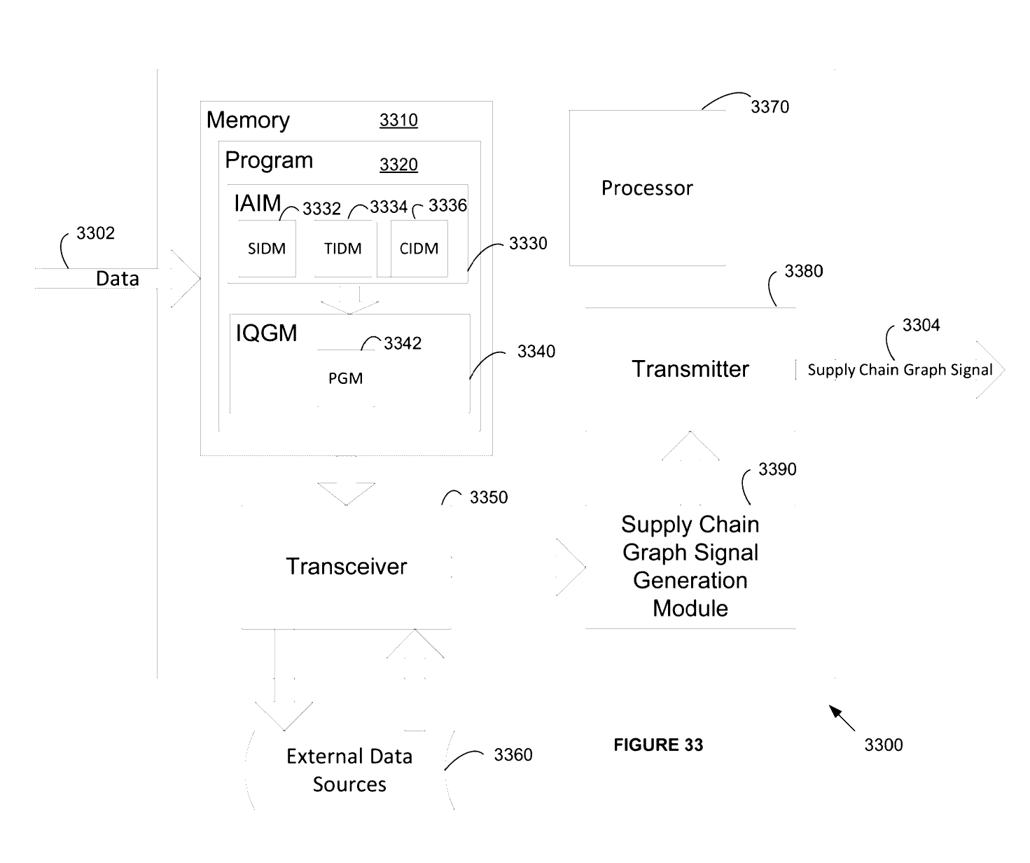

FIG. 33 depicts another embodiment of the SCGS system 3300 as embodied on a client computer system. The SCGS system 3300 is comprised of a processor 3370, a memory 3310, a transceiver 3350, a supply chain graph signal generation module (“SCGSGM”) 3390 and a transmitter 3380. A program 3320 stored in the memory 3310 is comprised of an Input and Identification Module (“IAIM”) 3330 and an Instantiated Query Generation Module (“IQGM”) 3340. The IAIM 330 is further comprised of a supplier identification module (“SIDM”) 3332, a commodity identification module (“TIDM”) 334, and a customer identification module (“CIDM”) 3336. The IQGM 3340 is further comprised of the placeholder generation module 3342. One or more external data sources 3360 are communicatively connected to the transceiver 3350.

A signal in the form of input data 3302 is first received by the system and parsed by the IAIM 3330. The IAIM 330 and its modules SIDM 3332, TIMD 3334, and CIDM 3336 parse the input data to identify a set of supplier entity names, commodities, and customer entity names. A corpus of predefined training data, including a set of company names and/or a set of commodity types, or other methods may be used to preload or train the IAIM 3330 with data used in identifying supplier entity names, commodities, and customer entity names. Once supplier entity names, commodities, and customer entity names have been identified by the IAIM 3330, the IQGM 3340 uses a set of query templates to generate a query using the supplier entity names, commodities, and customer entity names identified by the IAIM 3330. The placeholder generation module 3342 may be used to substitute one or more placeholder(s) into the query where no supplier entity name, commodity type, or customer entity name was identified.

The IQGM 3340 sends the instantiated query to the transceiver 3350 where the query is executed or submitted. A search using the instantiated query may be run on external data sources 3360. In one embodiment, the search is performed on a search engine, such as, but not limited to Yahoo! BOSS, to obtain the top 1,000 results containing the query parameters. The search results are returned from external data sources 360 to transceiver 3350. Each commodity type or company name returned by the query is a candidate result. The set of results returned by the search are converted into a set of triples. The set of triples contains a supplier entity, a commodity type, and a customer entity. The set of triples is then used by SCGSGM 3390 to construct a supply chain graph. In one exemplary implementation, the supply chain graph is generated by turning each of the supplier entity and customer entity into two graph nodes. The nodes are connected by a vertex labeled with the commodity type. The supply chain graph may use additional nodes and vertices by additional triples from the set of triples to the graph. The process of adding triples to the graph builds out a comprehensive supply chain graph that provides a user with an enhanced tool and experience in analyzing and forecasting supply and demand. The resulting supply chain graph signal generated by SCGSGM 390 is sent to transmitter 380 to be sent as supply chain graph signal 3304.

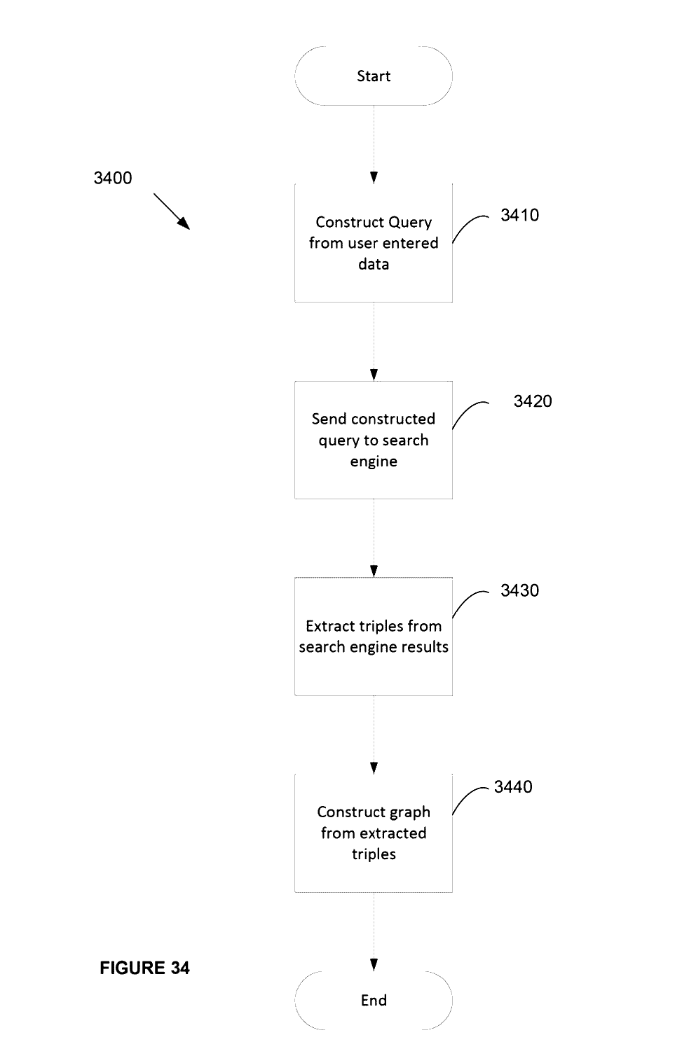

With reference now to FIG. 34, a flowchart depicts the process 3400, showing the steps involved in one embodiment of the invention. The process begins at step 3410 with the input of query data into the system by the user. The query data input by the user is formatted into a supply chain query to be used in obtaining supply chain information. The formatted query is then sent in step 3420 to a search engine or external data source. The query is used to perform a search to locate and identify data requested by the user. In operation multiple queries comprising essentially common elements (company, commodity, linguistic relationship terms) but having different formats may be executed. For example, the user may wish to identify all commodities supplied by BP to Shell Oil. The user would enter in the data “BP” as the supplying entity and “Shell Oil” as the customer entity in step 410. One query format that would be constructed would be in the form “BP supplies * to Shell Oil” wherein the “*” serves as a placeholder in the exemplary query. A second query format could be “Shell Oil receives * from BP.” A candidate result in step 3420 for this query would be any commodity that satisfies the conditions of the query for “*”, e.g., “natural gas” is a possible result for “BP supplies ‘natural gas’ to Shell Oil” or “Shell Oil receives ‘natural gas’ from BP.” At step 3430, sets of triples are extracted from the search engine results. In the above example, one triple would be “BP, natural gas, Shell Oil.” The full set of triples would comprise all results returned by the execution of the query or set of queries on the search engine. At step 3440 the search results are used to generate a supply chain graph. The supply chain graph is generated by turning each of the supplier entity and customer entity into two graph nodes. The nodes are connected by a vertex labeled with the commodity type. The supply chain graph may use additional nodes and vertices by additional triples from the set of triples to the graph. The resulting graph may be displayed to the user in either a graphical user interface or may be stored in memory to be used for other purposes.

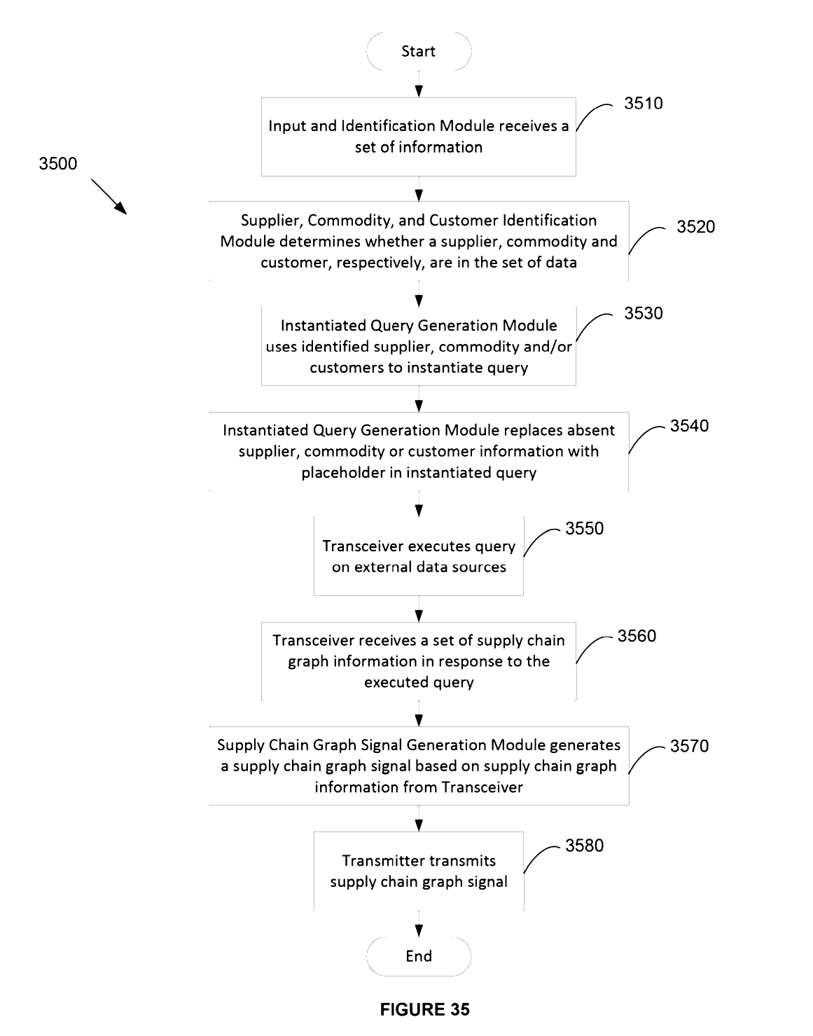

With reference now to FIG. 35, a flowchart depicts the process 3500, showing the steps involved in one embodiment of the invention. The process 3500 begins with an input and identification module receiving a set of information in step 3510. The information received by the input and identification module may include both unstructured and structured data from a variety of data sources. The supplier, commodity, and customer identification module in step 3520 determines whether supplier entity names, commodity types, and customer entity names are found within the set of data. Step 3520 may involve using a set of company names and a set of commodity types in addition to other data to identify supplier entity names, commodity types, and customer entity names within the set of data. For example, a user may select or define a set of companies of interest and/or a set of commodities of interest against which the user desires to apply the SCGS process. Alternatively, the set may comprise a set of companies common to an area or industry of interest.

In step 3530, an instantiated query generation module then uses the identified suppliers, commodities, and/or customers identified in the set of data to generate an instantiated querying using a query template from a set of query templates. The instantiated query may contain missing supplier entity names, commodity types, and customer entity names; if so, the instantiated query generation module will replace missing information with placeholders, which may be in the form of wildcards, in the instantiated query in step 3540. The instantiated query is sent to a transceiver in step 3550, where it is then executed on external data sources. In one embodiment, a search engine is used to return the top 1,000 results for the instantiated query. The set of results is received by the transceiver in step 3550 as a set of supply chain information in response to the query. In step 3560, a supply chain graph signal generation module generates a supply chain graph signal using the supply chain graph information from the transceiver. The supply chain graph signal is generated from a set of triples extracted from the supply chain graph information. The set of triples contains triples comprised of a supplier, a customer, and a commodity type. The supply chain graph signal is generated by turning each of the supplier entity and customer entity into two graph nodes. The nodes are connected by a vertex labeled with the commodity type. The supply chain graph may use additional nodes and vertices by adding additional triples from the set of triples to the graph. The resulting graph is then displayed to the user by the transmitter in step 3580 as either a visual representation in a graphical user interface or may be stored in memory to be used for other purposes.

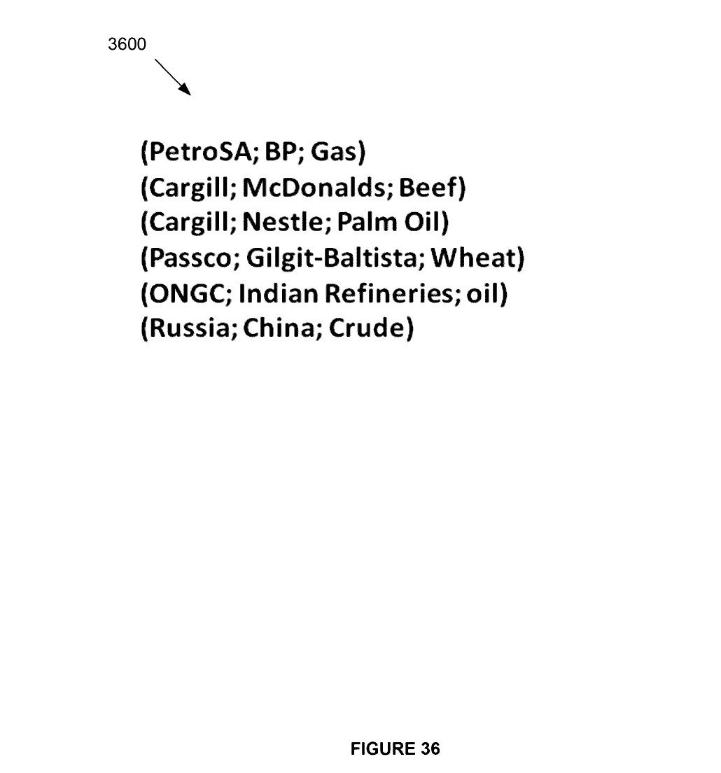

FIG. 36 depicts an exemplary embodiment of a set of triples 3600 that may be returned as the result of an executed instantiated query. Each triple in the set of triples comprises a supplying entity, a customer entity, and a commodity type. Each triple in the set of triples 3600 may be used to generate separate supply chain graphs. In addition, sets of triples with common elements, (Cargill; McDonalds; Beef) and (Cargill; Nestle; Palm Oil) for example, may be used to generate a single supply chain graph showing the commodity and supply relationships between multiple companies. The use of more than one triple in generating a supply chain graph will provide a more complete picture of the market environment and will assist the user in making determinations about risk in the supply chain and in analyzing and forecasting the supply and demand of resources represented in the graph. The graph or visualization may show an inter-relationship among a plurality of commodity types and companies with a company being a supplier of a first commodity and a customer or recipient of an other commodity, e.g., a received commodity used in generating the supplied commodity.

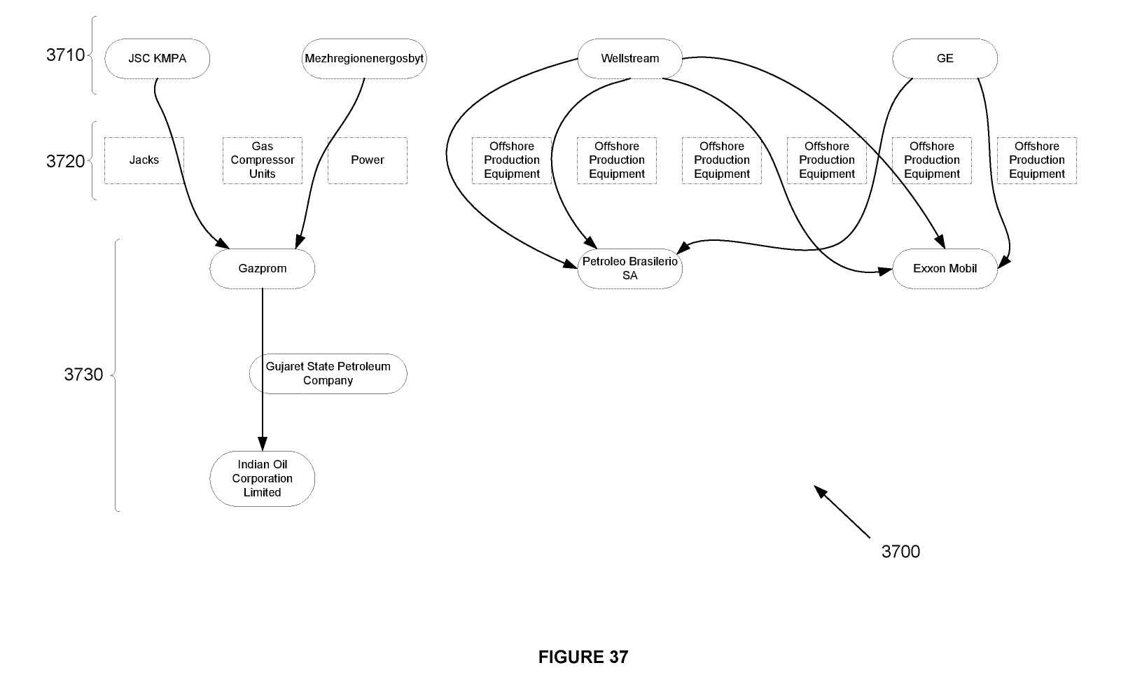

With reference now to FIG. 37, a first embodiment of a supply chain graph 3700 is depicted. The supply chain graph 3700 shows the interrelationship of a set of supplying entities 3710, commodity types 3720, and customer entities 3730. Each customer and supplier entity is represented as a graphical node on the graph. Each node is then connected to another node using a vertex. The vertices represent the supplier/customer relationship of two entities. In the supply chain graph 3700, the commodity type supplied from a supplier entity 3710 to a customer entity 3730 is shown by a vertex passing through a commodity type node 3720. For example, ‘JSC KMPA’ supplies ‘jacks’ to ‘Gazprom.” The graph also shows that ‘Gazprom’ sends the ‘jacks’ to ‘Indian Oil Corporation Limited’ through ‘Gujaret State Petroleum Company.’ Multiple relationships involving may triples from a set of triples returned as the result of a search using an instantiated query can be shown on a single graph. The supply chain graph 3700 uses at least 9 triples to show the relationships of the suppliers 3710, the commodity types 3720, and the customer entities 3730.

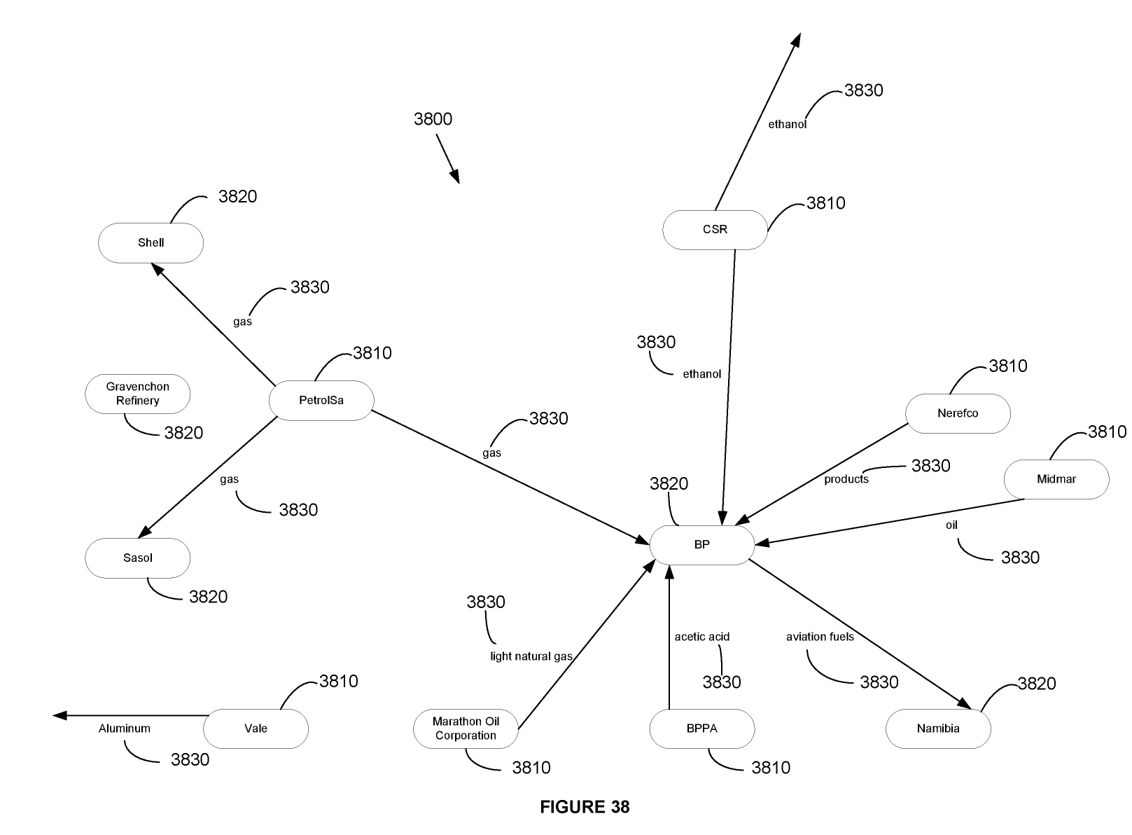

With reference now to FIG. 38, a second embodiment of a supply chain graph 3800 is depicted. Supply chain graph 3800 depicts an embodiment of a supply chain graph involving 11 triples to display the complete supplier and customer relationships returned using queries generated by the present invention. The set of triples returned by an instantiated query depict the interrelationships of 12 companies and 8 different commodity types. The set of commodity types 3830 are shown as labels on vertices connecting the set of supplier entities 3820 and the set of customer entities 3820. In the supply chain graph 3800 one such triple used would be (CSR; ethanol; BP), wherein CSR is the supplier, ethanol is the commodity type, and BP is the customer. The graph may be further annotated with the type of relationship between the customer and supplier shown on the vertex. For example, with respect to CSR and BP, the vertex “ethanol” may be further annotated with “manufactures for” or “processes for” to indicate how CSR and BP are related through ethanol. Additional triple may be added to the graph to further expand on the scope and give a clearer picture of the entities and commodity types involved.

While the invention has been described by reference to certain preferred embodiments, it should be understood that numerous changes could be made within the spirit and scope of the inventive concept described. In implementation, the inventive concepts may be automatically or semi-automatically, i.e., with some degree of human intervention, performed. Also, the present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

We claim:

1. A computer-based supply chain intelligence search engine comprising:
a server comprising a processor adapted to execute code and a memory for storing executable code;
an input adapted to receive a set of information derived from a set of information sources;
a first set of code when executed by the processor being adapted to automatically access a first set of information relating to a first set of locations of a set of transportation vehicles, the first set of locations being of the set of transportation vehicles at a first time and associated with a first journey, the first journey being in the present and not a previously completed journey;
a second set of code when executed by the processor being adapted to automatically access a second set of information relating to a second set of locations of the set of transportation vehicles, the second set of locations being of the set of transportation vehicles at a second time and associated with the first journey;
a third set of code when executed by the processor being adapted to automatically access a third set of information relating the set of transportation vehicles, the third set of information being related to a set of unique transportation vehicle identifiers;
a fourth set of code when executed by the processor being adapted to automatically access a fourth set of information relating to the set of transportation vehicles, the fourth set of information including a set of actual transaction data associated with a set of cargo types actually present on and being transported by the set of transportation vehicles during the first journey, the set of actual transaction data comprising data from at least one of the group consisting of: tender data; fixture data; and port inspection data;
a fifth set of code when executed by the processor being adapted to automatically access a fifth set of information not relating to the set of transportation vehicles;
a sixth set of code when executed by the processor being adapted to automatically forecast a set of tasks relating to the set of transportation vehicles and the set of cargo types, the set of tasks corresponding with the set of transportation vehicles, the set of tasks being based at least in part upon the first set of information, the second set of information, the third set of information, and the fourth set of information;
a seventh set of code when executed by the processor being adapted to automatically, based upon the set of tasks and the fifth set of information, generate a set of financial information relating to the set of cargo types and to store the set of financial information in the memory; and
an output adapted to transmit a signal associated with the generated set of financial information.
